(19) United States
(12) Patent Application Publication
(10) Pub. No.: US 2011/0001904 A1
(43) Pub. Date: Jan. 6, 2011

(54) CELLULOSE ESTER FILM, POLARIZER AND LIQUID CRYSTAL DISPLAY DEVICE

(75) Inventors: Hiromichi Tachikawa, Minami-ashigara-shi (JP); Jun Takeda, Minami-ashigara-shi (JP); Yoshiaki Hisakado, Minami-ashigara-shi (JP); Ryousuke Takada, Minami-ashigara-shi (JP); Akira Ikeda, Minami-ashigara-shi (JP); Mamoru Sakurazawa, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/828,623

(22) Filed: Jul. 1, 2010

(30) Foreign Application Priority Data
Jul. 2, 2009 (JP) 2009-158264

(51) Int. Cl. G02F 1/1335; C08B 3/00; B32B 5/00; G02B 5/30

(52) U.S. Cl. 349/96; 536/64; 428/220; 359/485

(57) ABSTRACT

A cellulose ester film comprising at least one polycondensate ester that comprises a dicarboxylic acid residue mixture having an average carbon number of from 5.5 to 10.0 and comprising an aromatic dicarboxylic acid residue and an aliphatic dicarboxylic acid residue, and an aliphatic diol residue having an average carbon number of from 2.5 to 7.0.

### CROSS-REFERENCE TO RELATED APPLICATIONS

The present application claims the benefit of priority from Japanese Patent Application No. 2009-158264, filed on Jul. 2, 2009, the contents of which are herein incorporated by reference in their entirety.

### BACKGROUND OF THE INVENTION

1. Field of the Invention

The present invention relates to a cellulose ester film, a polarizer, and a liquid-crystal display device.

2. Description of the Related Art

A polymer film of typically cellulose ester, polyester, polycarbonate, cycloolefin polymer, vinyl polymer, polyimide or the like is used in silver halide photographic materials, retardation films, polarizers and image display devices. Films more excellent in flatness and uniformity can be formed of these polymers, which are therefore widely employed as films for optical use. For example, a cellulose ester film having a suitable degree of moisture permeability can be stuck online directly to a most popular polarizing element comprising polyvinyl alcohol (PVA)/iodine. Accordingly, cellulose ester, especially cellulose acetate is widely employed as a protective film for polarizer.

In case where a transparent polymer film is used in optical applications for retardation films, supports for retardation films, protective films for polarizers, and liquid-crystal display devices, control of its optical anisotropy is an extremely important element in determination of the properties (e.g., visibility) of display devices.

On the other hand, for producing cellulose ester films for optical use, widely used is a solution casting method. In this case of film formation, a plasticizer is preferably added to the film-forming material for the purpose of imparting high-speed film formability thereto. This is because, adding a plasticizer makes it possible to shorten the time for evaporation of solvent in drying in film formation by solution casting. However, a transparent polymer film containing an ordinary plasticizer is often problematic in that, for example, when it is treated at a high temperature in a drying step or the like, it may emit smoke owing to the precipitation of the additives such as the plasticizer therein, or the vaporized oil and the like may adhere to the manufacturing machine to cause driving failure, or dust may adhere to the polymer film to cause surface defects. Accordingly, the production condition and the treatment condition for plasticizer-containing transparent films are naturally limited.

Accordingly, many polymer-type plasticizers have been proposed (for example, see WO05/061595), but have some problems in that their miscibility with cellulose ester is insufficient, the film haze is high, and in display devices, the contrast is insufficient. Even additives miscible with cellulose ester may precipitate from films after left for a long period of time, therefore worsening the properties of optical films, and this is a problem to be solved.

JP-A 2006-64803 discloses a stretched cellulose ester film containing a polyester polyol produced from a glycol having a carbon number of from 2 to 3.5 on average and a dibasic acid (anhydride) having a carbon number of from 4 to 5.5 on average, which is characterized in that the in-plane retardation of the film is from 30 to 200 nm and the thickness-direction retardation thereof is from 70 to 400 nm.

U.S. Pat. No. 6,495,656 and U.S. Pat. No. 6,342,304 disclose a technique of adding an aliphatic-aromatic polyester random copolymer for the purpose of producing a cellulose ester film excellent in the water vapor transmission rate and the biodegradability.

On the other hand, in a liquid-crystal display device, use of an optical compensatory film for enlarging the viewing angle, for improving the image coloration and for improving the contrast is a widely known technique. In most popular VA (vertically aligned)-mode or TN (twisted nematic)-mode display devices, especially desired is a retardation film of which the optical properties (e.g., Re, Rth) can be controlled to desired ones.

However, the cellulose ester film described in JP-A 2006-64803 is unsatisfactory in point of the expressibility of the optical properties for application to retardation films for optical use, and the film is difficult to apply to VA-mode liquid-crystal display devices requiring high-level optical anisotropy.

Regarding the cellulose ester film disclosed in JP-A 61-276836, the polyester or polyester polyol is poorly miscible with cellulose ester, therefore causing bleeding of additives such as plasticizer in film formation or in film stretching under heat; and therefore, the production efficiency is low and practical use of the film is difficult.

The compounds described in U.S. Pat. Nos. 6,495,656 and 6,342,304 have a large molecular weight and are unsatisfactory as their miscibility with cellulose ester is poor.

### SUMMARY OF THE INVENTION

An object of the invention is to provide an excellent cellulose ester film free from process contamination in its production and having high production efficiency.

Another object of the invention is to provide a retardation film comprising the cellulose ester film, of which the haze is small, the values Re and Rth can be controlled to desired ones, and the property change with time is small.

Still another object of the invention is to provide a polarizer comprising the cellulose ester film, which is excellent in display performance and durability.

Still another object of the invention is to provide a liquid-crystal display device comprising the polarizer and having good display quality.

The present inventors have assiduously studied and, as a result, have found that the above-mentioned problems can be solved by the following constitution:

[1] A cellulose ester film comprising at least one polycondensate ester that comprises a dicarboxylic acid residue mixture having an average carbon number of from 5.5 to 10.0 and comprising at least one aromatic dicarboxylic acid residue and at least one aliphatic dicarboxylic acid residue, and at least one aliphatic diol residue having an average carbon number of from 2.5 to 7.0.

[2] The cellulose ester film of [1], wherein the aromatic dicarboxylic acid residue in the dicarboxylic acid residue is at least 40 mol %.

[3] The cellulose ester film of [1] or [2], wherein the number-average molecular weight of the polycondensate ester is from 500 to 2000.

[4] The cellulose ester film of any one of [1] to [3], wherein the polycondensate ester is a polyester polyol.

[5] The cellulose ester film of any one of [1] to [4], wherein the terminal of the polycondensate ester is an aliphatic monocarboxylic acid residue.

[6] The cellulose ester film of [5], wherein the aliphatic monocarboxylic acid residue is an ester-forming derivative of an aliphatic monocarboxylic acid having a carbon number of at most 3.

[7] The cellulose ester film of any one of [1] to [6], wherein the cellulose ester film comprises a cellulose acylate and the degree of acyl substitution of the cellulose acylate is from 2.00 to 2.95.

[8] The cellulose ester film of [7], wherein the content of the polycondensate ester is from 5 to 40 parts by mass relative to 100 parts by mass of the cellulose acylate.

[9] The cellulose ester film of any one of [1] to [8], wherein the cellulose ester film is stretched in the cross direction, and the draw ratio in stretching is from 5% to 100% in the direction perpendicular to the machine direction (transporting direction).

[10] The cellulose ester film of any one of [1] to [9], wherein the cellulose ester film is formed according to a solution casting film formation method and then stretched.

[11] The cellulose ester film of [10], wherein the solution-casting film formation method is a simultaneous or successive multilayer casting film formation by co-casting.

[12] The cellulose ester film of any one of [1] to [11], satisfying the following formulae (1) and (2):

25 nm≦|Re(590)|≦100 nm, (1)

50 nm≦|Rth(590)|≦250 nm, (2)

wherein Re(590) and Rth(590) each mean the in-plane retardation and the thickness-direction retardation of the film as measured with a light having a wavelength of 590 nm at 25° C. and 60% RH.

[13] The cellulose ester film of any one of [1] to [12], having a thickness of from 30 to 100 μm.

[14] A polarizer having a protective film on both sides of a polarizing element, wherein at least one protective film is the cellulose ester film of any one of [1] to [13].

[15] A liquid-crystal display device comprising a liquid-crystal cell and two polarizers arranged on both sides thereof, wherein at least one polarizer is the polarizer of [14].

[16] The liquid-crystal display device of [15], wherein the liquid-crystal cell is a VA-mode liquid-crystal cell.

[17] A laminate produced by laminating an adhesive layer and the cellulose ester film of any one of [1] to [16].

[18] The laminate of [17], wherein the cellulose ester film comprises a polyester polyol in which the glycol unit has an average carbon number of from 2.5 to 3.0.

[19] The laminate of [17] or [18], wherein the cellulose ester film comprises a cellulose acylate having a total degree of acyl substitution of from 2.1 to 2.85.

[20] The laminate of [19], wherein the cellulose acylate is a cellulose acetate having a total degree of acyl substitution of from 2.3 to 2.6.

[21] The laminate of any one of [18] to [20], wherein the average carbon number of the dicarboxylic acid unit in the polyester polyol is at least 5.6

[22] The laminate of any one of [18] to [21], wherein the polyester polyol comprises an ethylene glycol unit and a polyethylene glycol unit.

[23] The laminate of any one of [18] to [22], wherein the 80 μm-thick haze of the polyester polyol is at most 5%.

[24] The laminate of any one of [17] to [23], which is such that, when the laminate is laminated on a glass sheet with the adhesive layer thereof kept in contact with the glass sheet, and left as such as 60° C. and a relative humidity of 90% for 1000 hours, and when the laminate is observed with a polarizing microscope, neither a needle-like crystal structure nor a granular structure is seen in the interface between the adhesive layer and the cellulose acylate film, and in the interface between the adhesive layer and the glass sheet, and the haze of the laminate is at most 5%.

[25] A polarizer having at least one laminate of any one of [17] to [24].

[26] The polarizer of [25], of which the contrast reduction ratio before and after left at 60° C. and a relative humidity of 90% for 1000 hours is at most 10%.

[27] A liquid-crystal display device having at least one laminate of any one of [17] to [26] or at least one polarizer of [25] or [26].

According to the invention, there are provided an excellent cellulose ester film which is free from a problem of process contamination in production and a problem of additive bleeding out, which has high production efficiency, which has good surface condition, and of which the value of Re and Rth can be controlled to desired ones; a retardation film having little property change in storage; and a polarizer excellent in durability. According to the invention, there is also provided a liquid-crystal display device comprising the above film or polarizer and having good display quality.

### BRIEF DESCRIPTION OF THE DRAWING

FIG. 1 is a cross-sectional view showing one example of a production method for the retardation film of the invention.

In the drawing, 70 is a cast film, 85 is a casting band, 86a is a rotary roller, 89 is a casting die, 120 is an inner layer dope, 121 is a surface A layer dope, 122 is a surface B layer dope, 120a is an inner layer, 121a is a surface A layer, 122a is a surface B layer, t1 is an internal layer thickness, t2 is a surface A layer thickness, t3 is a surface B layer thickness.

### BEST MODE FOR CARRYING OUT THE INVENTION

The cellulose ester film and its production method, and the additives for use for it are described in detail hereinunder.

The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

The cellulose ester film of the invention contains at least one polycondensate ester obtained from a mixture of dicarboxylic acids having an average carbon number of from 5.5 to 10.0 and containing at least one aromatic ring-having dicarboxylic acid and at least one aliphatic dicarboxylic acid, and at least one aliphatic diol having an average carbon number of from 2.5 to 7.0.

The cellulose ester film of the invention contains the above polycondensate ester, therefore expressing desired optical characteristics.

### [Polycondensate Ester]

The polycondensate ester in the invention is obtained from a mixture of at least one aromatic ring-having dicarboxylic acid (referred to also as an aromatic dicarboxylic acid) and at least one aliphatic dicarboxylic acid, for example, a dicarboxylic acid mixture having an average carbon number of from 5.5 to 10.0, and at least one aliphatic diol having an average carbon number of from 2.5 to 7.0.

The average carbon number of the aliphatic dicarboxylic acid residue is computed individually for the dicarboxylic acid residue and the diol residue.

The value computed by multiplying the composition ratio (molar fraction) of the dicarboxylic acid residue by the constitutive carbon number is taken as the average carbon number. For example, in case where the dicarboxylic acid residue is composed of an adipic acid residue and a phthalic acid residue of 50 mol % each, the average carbon number is computed to be 7.0.

The same shall apply also to the case of diol residue. The average carbon number of the aliphatic diol residue is a value as computed by multiplying the composition ratio (molar fraction) of the aliphatic diol residue by the constitutive carbon number. For example, in case where the diol residue is composed of an ethylene glycol residue of 50 mol % and a 1,2-propanediol residue of 50 mol %, the average carbon number is computed to be 2.5.

Preferably, the number-average molecular weight of the polycondensate ester is from 500 to 2000, more preferably from 600 to 1500, even more preferably from 700 to 1200. When the number-average molecular weight of the polycondensate ester is at least 600, the ester is poorly evaporative and is therefore free from problems of film failure and process contamination to be caused by ester evaporation under high-temperature condition in stretching the cellulose ester film. When the weight is at most 2000, then the polycondensate ester could be highly miscible with cellulose ester and may be free from a problem of bleeding out in film formation or in film stretching under heat.

The number-average molecular weight of the polycondensate ester of the invention can be measured and evaluated through gel permeation chromatography. The number-average molecular weight of the polyester polyol not blocked at the terminal can be computed in terms of the amount of the hydroxyl group per weight (hereinafter this is referred to as a hydroxyl value). The hydroxyl value can be determined by acetylating the polyester polyol and measuring the amount of potassium hydroxide (rag) necessary for neutralization of the excessive acetic acid.

In case where the cellulose ester film of the invention is laminated with an adhesive layer to give a laminate structure for the purpose of improving the wet heat durability of the resulting laminate structure, the molecular weight of the polycondensate is, though not specifically defined, preferably from 200 to 100000 as the weight-average molecular weight thereof, more preferably from 200 to 10000, even more preferably from 200 to 5000.

### <<Dicarboxylic Acid Unit>>

The dicarboxylic acid mixture of an aromatic dicarboxylic acid and an aliphatic dicarboxylic acid for use in the invention has a carbon number of from 5.5 to 10.0 on average, more preferably from 5.6 to 8.

In case where the cellulose ester film of the invention is laminated with an adhesive layer to give a laminate structure for the purpose of improving the wet heat durability of the resulting laminate structure, the glycol unit of the polycondensate ester to be used in the invention is preferably such that the dicarboxylic acid unit has an average carbon number of at least 5.6 from the viewpoint of the optical expressibility, more preferably from 5.6 to 8.0, even more preferably from 5.8 to 7.5.

When the average of the carbon number is at least 5.5, a polarizer excellent in durability can be obtained. When the average of the carbon number is at most 10, then the polycondensate ester could be highly miscible with cellulose ester and may be free from a problem of bleeding out in the process of cellulose ester film formation.

The polycondensate ester in the invention can serve as a plasticizer.

### (Aromatic Dicarboxylic Acid Residue)

The aromatic dicarboxylic acid residue is contained in the polycondensate ester produced from a diol and a dicarboxylic acid containing an aromatic dicarboxylic acid.

In this description, the residue means a partial structure of the polycondensate ester, and is a partial structure having the characteristic of the monomer that constitutes the polycondensate ester. For example, the dicarboxylic acid residue derived from a dicarboxylic acid HOOC—R—COOH is —OC—R—CO—.

The aromatic dicarboxylic acid residue ratio in the polycondensate ester for use in the invention is at least 40 mol %, preferably from 40 mol % to 95 mol %, more preferably from 45 mol % to 70 mol %, even more preferably from 50 mol % to 70 mol %.

When the aromatic dicarboxylic acid residue ratio is at least 40 mol %, then a cellulose ester having sufficient optical anisotropy can be obtained, and a polarizer excellent in durability can be obtained. When the ratio is at most 95 mol %, then the polycondensate ester is excellent in miscibility with cellulose ester and is hardly bleed out in formation of cellulose ester film and in stretching the film under heat.

The dicarboxylic acid unit in the polycondensate ester for use in the invention is meant to indicate the dicarboxylic acid residue existing between the ester bonds adjacent thereto. Preferably, the dicarboxylic acid unit in the polycondensate ester for use in the invention is one formed through reaction with an aromatic dicarboxylic acid having from 8 to 20 carbon atoms.

The aromatic dicarboxylic acid for use in the invention includes, for example, phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, and 2,6-naphthalenedicarboxylic acid. Preferred are phthalic acid, terephthalic acid, isophthalic acid, 1,5-naphthalenedicarboxylic acid, 1,4-naphthalenedicarboxylic acid, and 2,6-naphthalenedicarboxylic acid; and more preferred are phthalic acid, terephthalic acid, and isophthalic acid; and even more preferred is terephthalic acid.

In the polycondensate ester, the mixed aromatic dicarboxylic acid gives the aromatic dicarboxylic acid residue.

Concretely, the aromatic dicarboxylic residue preferably includes at least one of a phthalic acid residue, a terephthalic acid residue, and an isophthalic acid residue, more preferably at least one of a phthalic acid residue and a terephthalic acid residue, even more preferably includes a terephthalic acid residue.

Specifically, in mixing acids in forming the polycondensate ester, terephthalic acid is preferably used as the aromatic dicarboxylic acid, thereby giving a polycondensate ester excellent in miscibility with cellulose ester, and forming a cellulose ester film hardly causing bleeding out in film formation and in film stretching under heat. One or more aromatic dicarboxylic acids may be used either singly or as combined. In case where two such acids are combined, phthalic acid and terephthalic acid are preferably used.

Using two aromatic dicarboxylic acids of phthalic acid and terephthalic acid as combined is preferred in that the resulting polycondensate can be softened at room temperature and is easy to handle.

The content of the terephthalic acid residue in the dicarboxylic acid residue in the polycondensate ester is preferably from 40 mol % to 95 mol %, more preferably from 45 mol % to 70 mol %, even more preferably from 50 mol % to 70 mol %. When the terephthalic acid residue ratio is at least 40 mol %, then a cellulose ester film having sufficient optical anisotropy can be obtained. When the ratio is at most 95 mol %, then the resulting polycondensate ester is excellent in miscibility with cellulose ester and hardly bleeds out in formation of the intended cellulose ester film and in stretching the film under heat.

### (Aliphatic Dicarboxylic Acid Residue)

The aliphatic dicarboxylic acid residue is contained in the polycondensate ester produced from a diol and a dicarboxylic acid containing an aliphatic dicarboxylic acid.

In this description, the residue means a partial structure of the polycondensate ester, and is a partial structure having the characteristic of the monomer that constitutes the polycondensate ester. For example, the dicarboxylic acid residue derived from a dicarboxylic acid HOOC—R—COOH is —OC—R—CO—.

The dicarboxylic acid unit in the polycondensate ester for use in the invention is preferably one formed through reaction with an aliphatic dicarboxylic acid having from 4 to 20 carbon atoms.

The aliphatic dicarboxylic acid preferred for use in the invention includes, for example, oxalic acid, malonic acid, succinic acid, maleic acid, fumaric acid, glutaric acid, adipic acid, pimelic acid, suberic acid, azelaic acid, sebacic acid, dodecanedicarboxylic acid, and 1,4-cyclohexanedicarboxylic acid.

Of those, preferred aliphatic dicarboxylic acids are malonic acid, succinic acid, maleic acid, fumaric acid, glutaric acid, adipic acid, azelaic acid, and 1,4-cyclohexanedicarboxylic acid. More preferred aliphatic dicarboxylic acids are succinic acid, glutaric acid, and adipic acid.

In the polycondensate ester, the aliphatic dicarboxylic acid residue is derived from the aliphatic dicarboxylic acid used in mixing acids in forming the polycondensate ester.

Preferably, the aliphatic dicarboxylic acid residue has an average carbon number of from 5.5 to 10.0, more preferably from 5.5 to 8.0, even more preferably from 5.5 to 7.0.

Concretely, the ester preferably contains a succinic acid residue, and in case where the ester contains two acid residues, preferably it contains a succinic acid residue and an adipic acid residue.

Specifically, in mixing acids in forming the polycondensate ester, one or more aliphatic dicarboxylic acids may be used. In case where two such acids are used as combined, preferably succinic acid and adipic acid are used. In case where one acid is used, preferably used is succinic acid. The average carbon number of the dicarboxylic acid residues can be controlled to a desired value, and this is favorable in point of the miscibility of the polycondensate ester with cellulose ester.

In the invention, preferably, two or three dicarboxylic acids are sued. In case where two such acids are used, one aliphatic dicarboxylic acid and one aromatic dicarboxylic acid must be used; and in case where three such acids are used, one aliphatic dicarboxylic acid and two aromatic dicarboxylic acids, or two aliphatic dicarboxylic acids and one aromatic dicarboxylic acid may be used. The average carbon number of the dicarboxylic acid residues can be controlled with ease and the aromatic dicarboxylic acid residue content can be made to fall within a preferred range, and the durability of the polarizing element to be produced can be improved.

### <<Glycol (Diol) Unit>>

### (Aliphatic Diol)

The aliphatic diol residue is contained in the polycondensate ester produced from an aliphatic diol and a dicarboxylic acid containing an aromatic dicarboxylic acid and an aliphatic dicarboxylic acid.

In this description, the residue means a partial structure of the polycondensate ester, and is a partial structure having the characteristic of the monomer that constitutes the polycondensate ester. For example, the diol residue derived from a diol HO—R—OH is —O—R—O—.

The diol to form the polycondensate ester includes an aromatic diol and an aliphatic diol, and preferably, the diol comprises at least an aliphatic diol.

The glycol unit in the polycondensate ester for use in the invention is meant to indicate the diol residue existing between the ester bonds adjacent thereto. The glycol unit in the polycondensate ester for use in the invention is preferably an aliphatic diol residue, an alkyl ether diol residue, or an aromatic ring-containing diol residue, and is more preferably one formed through reaction with a glycol selected from an aliphatic diol having from 2 to 20 carbon atoms, an alkyl ether diol having from 4 to 20 carbon atoms, and an aromatic ring-containing dill having from 6 to 20 carbon atoms.

The polycondensate ester contains an aliphatic diol residue having an average carbon number of from 2.5 to 7.0. Preferred is an aliphatic diol having an average carbon number of from 2.5 to 4.0, and more preferred is an aliphatic diol residue having an average carbon number of from 2.5 to 4.0. Preferably, the glycol unit in the polycondensate ester for use in the invention has an average carbon number of from 2.5 to 3.0, from the viewpoint of improving the moisture resistance of the laminate produced by laminating the cellulose ester film containing the polycondensate ester with an adhesive layer. When the average carbon number of the aliphatic diol residue is more than 3.0, then the polycondensate ester is poorly miscible with cellulose ester and may often cause bleeding out, and if so, in addition, the loss on heating the compound may increase therefore bringing about film surface defects that may be caused by process contamination in drying the cellulose ester web. On the other hand, when the average carbon number of the aliphatic diol residue is less than 2.0, then the polycondensate ester may be difficult to produce.

The aliphatic diol for use in the invention includes alkyldiols and alicyclic diols, concretely, for example, ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, diethylene glycol, and cyclohexanedimethanol; and preferably, these are used either singly or as a mixture of two or more of them as combined with ethylene glycol.

Preferred aliphatic diols are ethylene glycol (1,2-ethanediol), propylene glycol (1,2-propanediol, 1,3-propanediol), 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, and 1,4-cyclohexanedimethanol; more preferred are ethylene glycol (1,2-ethanediol), propylene glycol (1,2-propanediol, 1,3-propanediol), 1,2-butanediol, 1,3-butanediol, 1,4-butanediol, 1,5-pentanediol, 1,6-hexanediol, 1,4-cyclohexanediol, and 1,4-cyclohexanedimethanol. Even more preferred is at least one of ethylene glycol, 1,2-propanediol, and 1,3-propanediol; and still more preferred is at least one of ethylene glycol and 1,2-propanediol. In case where two such diols are used, preferred are ethylene glycol and 1,2-propanediol. Use of 1,2-propanediol or 1,3-propanediol prevents crystallization of the formed polycondensate ester.

In the polycondensate ester, a diol residue is formed, as derived from the diol used in mixture.

Preferably, the diol residue contains at least one of an ethylene glycol residue, a 1,2-propanediol residue, and an 1,3-propanediol residue, and more preferably contains an ethylene glycol residue or a 1,2-propane diol residue.

In the aliphatic diol residue, preferably, the ethylene glycol residue is in a ratio of from 20 mol % to 100 mol %, more preferably from 50 mol % to 100 mol %.

The alkyl ether diol having a carbon number of from 4 to 20 includes, for example, polytetramethylene ether glycol, polyethylene ether glycol, polypropylene ether glycol, and their combination. Not specifically defined, its mean degree of polymerization is preferably from 2 to 20, more preferably from 2 to 10, even more preferably from 2 to 5, still more preferably from 2 to 4. Its examples include typically-useful commercial polyether glycols, such as Carbowax resins, Pluronics resins, and Niax resins.

Not specifically defined, the aromatic diol having a carbon number of from 6 to 20 includes hydroquinone, resorcinol, bisphenol A, bisphenol F, bisphenol, 1,2-hydroxybenzene, 1,3-hydroxybenzene, 1,4-hydroxybenzene, and 1,4-benzenedimethanol. Preferred are bisphenol A, 1,4-hydroxybenzene, and 1,4-benzenedimethanol.

These alkyl ether diols and aromatic diols can be used as a mixture with the above-mentioned aliphatic diol so far as the mixture satisfies the range of the average carbon number of the glycol unit to be in the polycondensate ester in the invention. In this case, for example, a mixture of ethylene glycol and diethylene glycol may be used to satisfy the range of the average carbon number of the glycol unit in the polycondensate ester in the invention.

### (Blocking)

The terminal of the polycondensate ester in the invention may be, not blocked, a diol or a carboxylic acid as such, or may be blocked (terminal blocking) through reaction with a monocarboxylic acid, a monoalcohol or a phenol. The terminal blocking is attained in order that the product film does not contain free carboxylic acids, and is effective for storage of the film.

In a preferred embodiment of the invention, the terminal hydroxyl group blocking ratio on both sides, as represented by the following formula (5), of the polyester polyol mentioned above is preferably at most 70%. The terminal hydroxyl group as referred to herein does not contain a part of the terminal carboxyl group (—COOH), —OH.

Terminal Hydroxyl Group Blocking Ratio on both sides (%)=100×(total number of the blocked hydroxyl groups existing at both terminals of polyester polyol)/{(total number of unblocked hydroxyl groups existing at both terminals of polyester polyol)+(total number of blocked hydroxyl groups existing at both terminals of polyester polyol)}. (5)

Preferably, the terminal hydroxyl group blocking ratio on both sides, as represented by the above formula (5), of the polyester polyol is at most 70%, more preferably at most 60%, even more preferably at most 50%. In that manner, further selecting polyester polyols of which the specific terminal hydroxyl group blocking ratio on both sides is controlled, from the polyester polyols in which the glycol unit has an average carbon number of from 2.5 to 3.0 improves the hydrophilicity/hydrophobicity of the resulting polycondensate ester.

On the other hand, the terminal carboxyl group blocking ratio on both sides, as represented by the following formula (5′), of the polyester polyol is preferably at most 70%, more preferably at most 60%, even more preferably at most 50%.

Terminal Carboxyl Group Blocking Ratio on both sides (%)=100×(total number of the blocked carboxyl groups existing at both terminals of polyester polyol)/{(total number of unblocked carboxyl groups existing at both terminals of polyester polyol)+(total number of blocked carboxyl groups existing at both terminals of polyester polyol)}. (5′)

Preferably, the terminal hydroxyl group blocking ratio on both sides and the terminal carboxyl group blocking ratio on both sides are both at most 70%, more preferably at most 60%, even more preferably at most 50%. Preferably, both ends of the polyester polyol are hydroxyl groups rather than carboxyl groups.

In the invention, preferably, both ends of the polyester polyol are hydroxyl groups not blocked with an alkyl group or an aromatic group, from the viewpoint of the miscibility of the polycondensate ester to be formed and the optical expressibility of the film to be formed.

Both ends of the polyester additive in the invention may be protected with a monoalcohol residue or a monocarboxylic acid residue so that the two ends are not carboxyl groups or hydroxyl groups.

In this case, the monoalcohol is preferably a substituted or unsubstituted monoalcohol having a carbon number of from 1 to 30, including an aliphatic alcohol such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, and oleyl alcohol; and a substituted alcohol such as benzyl alcohol, and 3-phenylpropanol.

Preferred examples of the terminal-blocking alcohol for use in the invention include methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, and benzyl alcohol; and more preferred are methanol, ethanol, propanol, isobutanol, cyclohexyl alcohol, 2-ethylhexyl alcohol, isononyl alcohol, and benzyl alcohol.

In case where the terminal is blocked with a monocarboxylic acid residue, the monocarboxylic acid used for the monocarboxylic acid residue is preferably a substituted or unsubstituted monocarboxylic acid having a carbon number of from 1 to 30. The acid may be an aliphatic monocarboxylic acid or an aromatic ring-containing carboxylic acid. Preferred aliphatic monocarboxylic acids are described. They include acetic acid, propionic acid, butanoic acid, caprylic acid, caproic acid, decanoic acid, dodecanoic acid, stearic acid, and oleic acid. The aromatic ring-containing monocarboxylic acid includes, for example, benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, and acetoxybenzoic acid. One or more of these may be used.

As the monocarboxylic acid for use for blocking, preferred are acetic acid, propionic acid, and butanoic acid, more preferred are acetic acid, and propionic acid, and most preferred is acetic acid. As the monoalcohol for use for blocking, preferred are methanol, ethanol, propanol, isopropanol, butanol and isobutanol, and most preferred is methanol. When the monocarboxylic acid for use for the terminal of the polycondensate ester has a carbon number of at most 3, then the loss on heating the compound is not large and the formed film may be free from surface defects.

More preferably, the terminal of the polycondensate ester in the invention is, not blocked, a diol residue as such, or even more preferably, the terminal is blocked with acetic acid or propionic acid.

Both terminals of the polycondensate for use in the invention may be blocked or unblocked.

In case where both terminals of the polycondensate ester are unblocked, the polycondensate ester is preferably a polyester polyol.

One embodiment of the polycondensate ester in the invention is a polycondensate ester in which the aliphatic diol residue has a carbon number of from 2.5 to 7.0 and of which both terminals are unblocked.

In case where both terminals of the polycondensate ester are blocked, the ester is preferably blocked through reaction with a monocarboxylic acid. In this case, both terminals of the polycondensate ester are monocarboxylic acid residues. In this description, the residue means a partial structure of the polycondensate ester, and is a partial structure having the characteristic of the monomer that constitutes the polycondensate ester. For example, the monocarboxylic acid residue derived from a monocarboxylic acid R—COOH is R—CO—. Preferred is an aliphatic monocarboxylic acid residue, and more preferred is an aliphatic monocarboxylic acid residue at most 22 carbon atoms. Most preferred is an aliphatic monocarboxylic acid residue having at most 3 carbon atoms. Also preferred is an aliphatic monocarboxylic acid residue having at least 2 carbon atoms, and more preferred is an aliphatic monocarboxylic acid having 2 carbon atoms.

One embodiment of the polycondensate ester in the invention is a polycondensate ester in which the aliphatic diol residue has a carbon number of from 2.5 to 7.0 and of which both terminals are monocarboxylic acid residues.

When the carbon number of the monocarboxylic acid residue on both terminals of the polycondensate ester is at most 3, then the volatility of the polycondensate ester lowers and the loss on heating polycondensate ester is not large, and the risk of process contamination and surface defects in film formation may be reduced.

Specifically, as the monocarboxylic acid for use for blocking, preferred is an aliphatic monocarboxylic acid. More preferred is an aliphatic monocarboxylic acid having from 2 to 22 carbon atoms; even more preferred is an aliphatic monocarboxylic acid having 2 or 3 carbon atoms; still more preferred is an aliphatic monocarboxylic acid having 2 carbon atoms.

For example, preferred are acetic acid, propionic acid, butanoic acid and their derivatives; more preferred are acetic acid and propionic acid; and most preferred is acetic acid.

Two or more monocarboxylic acids may be combined for use for blocking.

Both terminals of the polycondensate ester in the invention are preferably blocked with acetic acid or propionic acid; and most preferably, these are blocked with acetic acid to be acetyl ester residues (these may be referred to as acetyl residues).

When both terminals are blocked, the ester could hardly be solid at room temperature and its handling is good; and in such a case, in addition, a cellulose ester film and a polarizer excellent in moisture stability and durability can be obtained.

Examples of polycondensate esters falling within the invention, A-1 to A-31, B-3, B-4, B-6, B-9 and B-10, and examples of polycondensate esters falling outside the scope of the invention, B-1, B-2, B-5, B-7 and B-8 are shown in Table 1 below, and examples of polycondensates that may be in the cellulose ester film of the invention are in Table 2, to which, however, the invention should not be limited.

TABLE 1

| | Dicarboxylic Acid*¹⁾ | | | | Diol | | | | | Number- |
|---|---|---|---|---|---|---|---|---|---|---|
| | Aromatic | Aliphatic | Ratio of | Average | | | | Average | | Average |
| | Dicarboxylic | Dicarboxylic | Dicarboxylic | Carbon | | | Ratio of Diols | Carbon | | Molecular |
| | Acid | Acid | Acids (mol %) | Number | Diol 1 | Diol 2 | (mol %) | Number | Terminal | Weight |
| A-1 | TPA | SA | 45/55 | 5.80 | ethanediol | propanediol | 45/55 | 2.55 | acetyl ester residue | 750 |
| A-2 | TPA | SA | 50/50 | 6.00 | ethanediol | propanediol | 45/55 | 2.55 | acetyl ester residue | 750 |
| A-3 | TPA | SA | 55/45 | 6.20 | ethanediol | propanediol | 45/55 | 2.55 | acetyl ester residue | 750 |
| A-4 | TPA | SA | 65/35 | 6.60 | ethanediol | propanediol | 45/55 | 2.55 | acetyl ester residue | 750 |
| A-5 | TPA | SA | 55/45 | 6.20 | ethanediol | propanediol | 25/75 | 2.75 | acetyl ester residue | 800 |
| A-6 | TPA | SA | 55/45 | 6.20 | ethanediol | propanediol | 10/90 | 2.90 | acetyl ester residue | 800 |
| A-7 | 2,6-NPA | SA | 50/50 | 8.00 | ethanediol | propanediol | 45/55 | 2.55 | acetyl ester residue | 850 |
| A-8 | 2,6-NPA | AA | 50/50 | 9.00 | ethanediol | propanediol | 45/55 | 2.55 | acetyl ester residue | 850 |
| A-9 | TPA/PA | SA | 45/5/50 | 6.00 | ethanediol | propanediol | 45/55 | 2.55 | acetyl ester residue | 1500 |
| A-10 | TPA/PA | SA | 40/10/50 | 6.00 | ethanediol | propanediol | 45/55 | 2.55 | acetyl ester residue | 1200 |
| A-11 | TPA | SA/AA | 50/30/20 | 6.40 | ethanediol | propanediol | 45/55 | 2.55 | acetyl ester residue | 1200 |
| A-12 | TPA | SA/AA | 50/20/30 | 6.60 | ethanediol | propanediol | 45/55 | 2.55 | acetyl ester residue | 1000 |
| A-13 | TPA | AA | 50/50 | 7.00 | ethanediol | propanediol | 45/55 | 2.55 | acetyl ester residue | 750 |
| A-14 | TPA | SA | 55/45 | 6.20 | ethanediol | butanediol | 25/75 | 3.50 | acetyl ester residue | 1800 |
| A-15 | TPA | SA | 55/45 | 6.20 | ethanediol | cyclohexane- | 25/75 | 6.50 | acetyl ester residue | 850 |
| | | | | | | dimethanol | | | | |
| A-16 | TPA | SA | 45/55 | 5.80 | ethanediol | propanediol | 45/55 | 2.55 | hydroxyl group | 750 |
| A-17 | TPA | SA | 50/50 | 6.00 | ethanediol | propanediol | 45/55 | 2.55 | hydroxyl group | 750 |
| A-18 | TPA | SA | 55/45 | 6.20 | ethanediol | propanediol | 45/55 | 2.55 | hydroxyl group | 750 |
| A-19 | TPA | SA | 65/35 | 6.60 | ethanediol | propanediol | 45/55 | 2.55 | hydroxyl group | 750 |
| A-20 | TPA | SA | 55/45 | 6.20 | ethanediol | propanediol | 25/75 | 2.75 | hydroxyl group | 1800 |
| A-21 | TPA | SA | 55/45 | 6.20 | ethanediol | propanediol | 10/90 | 2.90 | hydroxyl group | 1200 |
| A-22 | 2,6-NPA | SA | 50/50 | 8.00 | ethanediol | propanediol | 25/75 | 2.75 | hydroxyl group | 1000 |
| A-23 | 2,6-NPA | AA | 50/50 | 9.00 | ethanediol | propanediol | 25/75 | 2.75 | hydroxyl group | 850 |
| A-24 | TPA/PA | SA | 45/5/50 | 6.00 | ethanediol | propanediol | 25/75 | 2.75 | hydroxyl group | 850 |
| A-25 | TPA/PA | SA | 40/10/50 | 6.00 | ethanediol | propanediol | 25/75 | 2.75 | hydroxyl group | 900 |
| A-26 | TPA | SA/AA | 50/30/20 | 6.40 | ethanediol | propanediol | 25/75 | 2.75 | hydroxyl group | 750 |
| A-27 | TPA | SA/AA | 50/20/30 | 6.60 | ethanediol | propanediol | 25/75 | 2.75 | hydroxyl group | 850 |
| A-28 | TPA | AA | 50/50 | 7.00 | ethanediol | propanediol | 25/75 | 2.75 | hydroxyl group | 900 |
| A-29 | TPA | SA | 55/45 | 6.20 | ethanediol | butanediol | 25/75 | 3.50 | hydroxyl group | 1800 |
| A-30 | TPA | SA | 55/45 | 6.20 | ethanediol | cyclohexane- | 25/75 | 6.50 | hydroxyl group | 850 |
| | | | | | | dimethanol | | | | |
| A-31 | TPA | SA | 55/45 | 6.20 | ethanediol | propanediol | 45/55 | 2.55 | propionyl ester residue | 750 |
| B-1 | TPA | SA | 35/65 | 5.40 | ethanediol | propanediol | 45/55 | 2.55 | acetyl ester residue | 850 |
| B-2 | TPA | SA | 30/70 | 5.20 | ethanediol | propanediol | 45/55 | 2.55 | acetyl ester residue | 900 |
| B-3 | TPA | AA | 35/65 | 6.70 | ethanediol | propanediol | 45/55 | 2.55 | acetyl ester residue | 750 |
| B-4 | 2,6-NPA | SA | 50/50 | 8.00 | ethanediol | propanediol | 45/55 | 2.55 | acetyl ester residue | 850 |
| B-5 | 2,6-NPA | AA | 70/30 | 10.20 | ethanediol | propanediol | 45/55 | 2.55 | acetyl ester residue | 1200 |
| B-6 | TPA | SA | 55/45 | 6.20 | | butanediol | 100 | 4.00 | hydroxyl group | 900 |
| B-7 | TPA | SA | 55/45 | 6.20 | | cyclohexane- | 100 | 8.00 | hydroxyl group | 850 |
| | | | | | | dimethanol | | | | |
| B-8 | TPA | SA | 55/45 | 620 | ethanediol | | 100 | 2.00 | hydroxyl group | 750 |
| B-9 | TPA | SA | 55/45 | 6.20 | ethanediol | propanediol | 45/55 | 2.55 | hydroxyl group | 450 |
| B-10 | TPA | SA | 55/45 | 6.20 | ethanediol | propanediol | 45/55 | 2.55 | hydroxyl group | 2500 |

*¹⁾PA: phthalic acid, TPA: terephthalic acid, IPA: isophthalic acid, AA: adipic acid, SA: succinic acid, 2,6-NPR: 2,6-naphthalenedicarboxylic acid.

TABLE 2

| | Glycol Unit | | | | | Dicarboxylic Acid Unit | | | | | | |
|---|---|---|---|---|---|---|---|---|---|---|---|---|
| | Hydroxyl Group | | | | Average | | | | | Average | | |
| Polycondensate | Blocking Ratio | EG | PG | BG | Carbon | TPA | PA | AA | SA | Carbon | SP | Molecular |
| Ester | on both terminals (%) | (mol %) | (mol %) | (mol %) | Number | (mol %) | (mol %) | (mol %) | (mol %) | Number | (MPa^{-1/2}) | Weight |
| A | 100 | 100 | 0 | 0 | 2 | 45 | 5 | 20 | 30 | 6 | 22.3 | 840 |
| B | 0 | 100 | 0 | 0 | 2 | 45 | 5 | 20 | 30 | 6 | 23.9 | 680 |
| C | 100 | 0 | 100 | 0 | 3 | 45 | 5 | 50 | 0 | 6 | 21.2 | 900 |
| D | 0 | 50 | 50 | 0 | 2.5 | 55 | 0 | 0 | 45 | 6.2 | 23.6 | 690 |
| E | 100 | 50 | 50 | 0 | 2.5 | 55 | 0 | 0 | 45 | 6.2 | 21.9 | 730 |
| F | 100 | 40 | 60 | 0 | 2.6 | 55 | 0 | 0 | 45 | 6.2 | 21.8 | 670 |
| G | 100 | 50 | 50 | 0 | 2.5 | 45 | 5 | 20 | 30 | 6 | 21.8 | 770 |
| H | 0 | 25 | 75 | 0 | 2.75 | 45 | 10 | 0 | 45 | 6.2 | 23.3 | 690 |
| I | 0 | 50 | 50 | 0 | 2.5 | 45 | 10 | 0 | 45 | 6.2 | 23.4 | 800 |
| J | 0 | 25 | 75 | 0 | 2.75 | 45 | 20 | 0 | 35 | 6.6 | 23.2 | 770 |
| K | 0 | 25 | 75 | 0 | 2.75 | 45 | 5 | 0 | 50 | 6 | 23.2 | 790 |
| L | 40 | 25 | 75 | 0 | 2.75 | 45 | 5 | 0 | 50 | 6 | 22.6 | 790 |
| M | 0 | 25 | 75 | 0 | 2.75 | 50 | 10 | 0 | 40 | 6.4 | 23.2 | 760 |
| N | 100 | 40 | 60 | 0 | 2.6 | 45 | 5 | 50 | 0 | 6 | 21.5 | 900 |
| O | 100 | 80 | 20 | 0 | 2.2 | 45 | 5 | 0 | 50 | 6 | 22.3 | 1000 |
| P | 100 | 35 | 0 | 65 | 3.3 | 45 | 5 | 0 | 50 | 6 | 21.1 | 1000 |
| Q | 100 | 65 | 35 | 0 | 2.35 | 55 | 0 | 0 | 45 | 6.2 | 22.1 | 800 |
| R | 100 | 10 | 90 | 0 | 2.9 | 55 | 0 | 0 | 45 | 6.2 | 21.6 | 800 |
| S | 100 | 0 | 90 | 10 | 3.1 | 55 | 0 | 0 | 45 | 6.2 | 21.3 | 800 |

In Table 2, EG means ethylene glycol; PG means propylene glycol; BG means butylene glycol; TPA means terephthalic acid; PA means phthalic acid; AA means adipic acid; SA means succinic acid.

The polycondensate ester in the invention can be produced with ease according to a hot melt condensation method or ordinary polyesterification or interesterification of a diol and a dicarboxylic acid and/or a terminal-blocking monocarboxylic acid or alcohol, or according to an interfacial condensation method of reacting an acid chloride of such an acid and a glycol. The polycondensate ester for use in the invention is described in detail by Koichi Mural in “Plasticizer and its Theory and Application” (Miyuki Shobo, original 1st Ed., published Mar. 1, 1973). In addition, the materials described in JP-A 05-155809, 05-155810, 5-197073, 2006-259494, 07-330670, 2006-342227, 2007-003679 are also usable herein.

The content of the polycondensate ester in the cellulose ester film of the invention is preferably from 5 to 40% by mass of the amount of the cellulose ester therein, more preferably from 8 to 30% by mass, most preferably from 10 to 25% by mass.

On the other hand, in case where the cellulose ester film of the invention is laminated with an adhesive layer to give a laminate for further improving the wet heat durability of the laminate, the amount (content) of the polyester polyol is preferably from 3% by mass to 30% by mass relative to the film, more preferably from 5% by mass to 25% by mass, even more preferably from 5% by mass to 20% by mass.

Preferably, the 80 μm-thick haze of the polycondensate ester is at most 5%, more preferably at most 4%, even more preferably at most 3%. The 80 μm-thick haze of the polycondensate ester means the haze of the ester as measured by sandwiching it between two glass sheets combined with a 80 μm gap therebetween, according to the method to be mentioned below.

The content of the starting materials, aliphatic diol, dicarboxylate and diol ester for the polycondensate in the cellulose ester film of the invention is preferably less than 1% by mass, more preferably less than 0.5% by mass. The dicarboxylate includes dimethyl phthalate, di(hydroxyethyl)phthalate, dimethyl terephthalate, di(hydroxyethyl)terephthalate, di(hydroxyethyl)adipate, and di(hydroxyethyl)succinate. The diol ester includes ethylene diacetate, and propylene diacetate.

The type and the ratio of the residues of the dicarboxylic acid residue, the diol residue and the monocarboxylic acid residue contained in the polycondensate ester for use in the invention can be determined according to an ordinary method of H-NMR. In general, heavy chloroform is used as the solvent.

The number-average molecular weight of the polycondensate can be measured according to an ordinary method of GPC (gel permeation chromatography), in which, in general, polystyrene is used as the standard sample.

The hydroxyl value of the polycondensate ester can be measured according to an acetic anhydride method described in Japanese Industrial Standards, JIS K3342 (obsolete). In case where the polycondensate is a polyester polyol, its hydroxyl value is preferably from 50 to 190, more preferably from 50 to 130.

The cellulose ester film usable for optical compensatory films, polarizers and the like is described in detail hereinunder.

### [Cellulose Ester]

The cellulose ester in the cellulose ester film of the invention includes a cellulose ester compound, and a compound having an ester-substituted cellulose skeleton that is produced by biologically or chemically introducing a functional group into a starting material cellulose. The cellulose ester film of the invention preferably contains the above-mentioned cellulose ester as the main ingredient thereof. “Main ingredient” as referred to herein means a single polymer when the substance is composed of a single polymer, but when the substance comprises a plurality of polymers, “main ingredient” means the polymer having the highest mass fraction of all the constitutive polymers.

The cellulose ester is an ester of cellulose and an acid. The acid constituting the ester is preferably an organic acid, more preferably a carboxylic acid, even more preferably a fatty acid having a carbon number of from 2 to 22. Most preferred is a cellulose acylate with a lower fatty acid having a carbon number of from 2 to 4.

### [Starting Cotton for Cellulose Acylate]

The starting cellulose for the cellulose acylate for use in the invention includes cotton linter and wood pulp (hardwood pulp, softwood pulp), etc.; and any cellulose obtained from any starting cellulose can be used herein. As the case may be different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8. Cellulose materials described in these may be used for the cellulose acylate film for the invention with no specific limitation.

The cellulose acylate preferably used in the invention is described in detail. The β-1,4-bonding glucose unit to constitute cellulose has a hydroxyl group at the 2-, 3- and 6-positions. The cellulose acylate is a polymer produced by esterifying a part or all of those hydroxyl groups in cellulose with an acyl group having 2 or more carbon atoms. The degree of acyl substitution means the ratio of esterification of the hydroxyl group in cellulose positioned in the 2-, 3- and 6-positions in the unit therein. In case where the hydroxyl group is 100% esterified in every position, the whole degree of acyl substitution is 3 in total.

### [Degree of Substitution in Cellulose Acylate]

Preferred cellulose acylates for use in the invention that are produced from the above-mentioned starting cellulose are described below.

The cellulose acylate for use in the invention is a cellulose derivative in which the hydroxyl group is acylated, and in this, the substituent may be any acyl group of from an acetyl group having 2 carbon atoms to the other acyl group having up to 22 carbon atoms. The degree of substitution of the hydroxyl group in cellulose to give the cellulose acylate for use in the invention is not specifically defined. For example, the bonding degree of acetic acid and/or other fatty acid having from 3 to 22 carbon atoms to substitute for the hydroxyl group in cellulose is measured, and the degree of substitution can be determined through computation of the data. For the measuring method, referred to is ASTM D-8,7-91.

Preferably, the cellulose ester film is composed of a cellulose acylate. The degree of substitution of the hydroxyl group in cellulose is not specifically defined. Preferably, the degree of acyl substitution in the cellulose acylate film is from 2.00 to 2.95, more preferably from 2.10 to 2.80, even more preferably from 2.20 to 2.70, still more preferably from 2.30 to 2.60.

On the other hand, in case where the cellulose ester film of the invention is laminated with an adhesive layer to give a laminate of the invention for further enhancing the wet heat durability of the laminate, the total degree of acylation, or that is, DS2+DS3+DS6 is preferably from 2.3 to 2.6, more preferably from 2.35 to 2.5, even more preferably from 2.35 to 2.50. Also preferably, DS6/(DS2+DS3+DS6) is from 0.08 to 0.66, more preferably from 0.15 to 0.60, even more preferably from 0.20 to 0.45. DS2 means the degree of substitution of the 2-positioned hydroxyl group in the glucose unit with an acyl group (hereinafter this may be referred to as “degree of 2-position acyl substitution”; DS3 means the degree of substitution of the 3-positioned hydroxyl group with an acyl group (hereinafter this may be referred to as “degree of 3-position acyl substitution”; DS6 means the degree of substitution of the 6-positioned hydroxyl group with an acyl group (hereinafter this may be referred to as “degree of 6-position acyl substitution”. DS6/(DS2+DS3+DS6) indicates the ratio of the degree of 6-position acyl substitution to the total degree of acyl substitution (hereinafter this may be referred to as “6-position acyl substitution ratio”).

On the other hand, in case where the cellulose ester film of the invention is laminated with an adhesive layer to give a laminate of the invention for further enhancing the wet heat durability of the laminate, the cellulose acylate may have one type of acyl group or may have two or more different types of acyl groups. Preferably, the cellulose acylate has an acyl group having from 2 to 4 carbon atoms as the substituent. In case where the acylate has two or more different types of acyl groups, one of the groups is preferably an acetyl group, and the acyl group having from 2 to 4 carbon atoms is preferably a propionyl group or a butyryl group. The total degree of substitution with an acetyl group at the 2-position, 3-position and 6-position hydroxyl groups is represented by DSA, and the total degree of substitution with a propionyl group or a butyryl group in the 2-position, 3-position and 6-position hydroxyl groups is by DSB. The value of DSA+DSB is preferably from 2.3 to 2.6. More preferably, the value of DSA+DSB is from 2.35 to 2.55, and DSB is from 0.10 to 1.70. Even more preferably, the value of DSA+DSB is from 2.40 to 2.50, and DSB is from 0.5 to 1.2. When DSA and DSB are defined to fall within the above range, it is desirable since a film with little environmental moisture-dependent fluctuation of Re and Rth can be produced.

At least 28% of DSB is the substituent at the 6-position hydroxyl group; but preferably at least 30% thereof is the substituent at the 6-position hydroxyl group, more preferably at least 31% thereof is the substituent at the 6-position hydroxyl group, even more preferably at least 32% thereof is the substituent at the 6-position hydroxyl group. The ester of the type may form a solution of good solubility, and especially it enables formation of a good solution in a chlorine-free organic solvent. In addition, the ester enables formation of a solution having a low viscosity and having good filterability.

When the degree of acyl substitution is at least 2.00, then the cellulose ester is satisfactory in point of the moisture stability of the film to be formed and of the durability of the polarizer to be formed. When the degree of acyl substitution is at most 2.95, then the cellulose ester is favorable as excellent in the solubility in organic solvent and in the miscibility with the polycondensate ester. When the degree of acyl substitution of the cellulose acylate falls within the preferred range, then it is favorable since the cellulose acylate film is excellent in point of the optical properties thereof.

The acyl group having from 2 to 22 carbon atoms which is from acetic acid and/or fatty acid having from 3 to 22 carbon atoms and which substitutes for the hydroxyl group of cellulose may be an aliphatic group or an aryl group with no specific limitation thereon, and one or more different types of acyl groups may be in the ester either singly or as combined. For example, the ester is an alkylcarbonyl ester, an alkenylcarbonyl ester, an aromatic carbonyl ester or an aromatic alkylcarbonyl ester of cellulose, in which the acyl group may be further substituted. Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, i-butanoyl, t-butanoyl, cyclohexanecarbonyl, oleoyl, benzoyl, naphthylcarbonyl, cinnamoyl, etc. Of those, preferred are acetyl, propionyl, butanoyl, dodecanoyl, octadecanoyl, t-butanoyl, oleoyl, benzoyl, naphthylcarbonyl, and cinnamoyl; more preferred are acetyl, propionyl and butanoyl. Even more preferred are acetyl and propionyl; and most preferred is acetyl.

### [Degree of Polymerization of Cellulose Acylate]

The degree of polymerization of cellulose acylate preferred for use in the invention is from 180 to 700 in terms of the viscosity-average degree of polymerization thereof. Preferably, cellulose acetate has the degree of from 180 to 550, more preferably from 180 to 400, even more preferably from 180 to 350. When the degree of polymerization is at most the upper limit, then it is favorable since the viscosity of the cellulose acylate dope solution is not too high and film formation by casting may be easy. When the degree of polymerization is at least the lower limit, then it is also favorable since the formed film is free from disadvantage of intensity reduction. The viscosity-average degree of polymerization can be determined according to Uda et al's limiting viscosity method {Kazuo Uda & Hideo Saito, “Journal of Society of Fiber Science and Technology of Japan, Vol. 18, No. 1, pp. 105-120 (1962)}. The method is described in detail in JP-A 9-95538.

The molecular weight distribution of the cellulose acylate preferred for use in the invention may be evaluated through gel permeation chromatography; and preferably, the polydispersity index Mw/Mn thereof (Mw is mass-average molecular weight, Mn is number-average molecular weight) is small and the molecular weight distribution thereof is narrow. Concretely, Mw/Mn of the cellulose acylate is preferably from 1.0 to 4.0, more preferably from 2.0 to 4.0, most preferably from 2.3 to 3.4.

In acylation of cellulose, when an acid anhydride or an acid chloride is used as the acylating agent, the organic solvent for the reaction solvent to be used may be an organic acid such as acetic acid, or methylene chloride.

In case where the acylating agent is an acid anhydride, the catalyst is preferably a protic catalyst such as sulfuric acid; while in case where the acylating agent is an acid chloride (e.g., CH₃CH₂COCl), used is a basic compound.

A most general industrial production method for a mixed acid ester of cellulose comprises acylating cellulose with a mixed organic acid component that contains a fatty acid corresponding to acetyl group and other acyl group (e.g., acetic acid, propionic acid, valeric acid) or its anhydride.

The cellulose acylate for use in the invention can be produced according to the method, for example, described in JP-A 10-45804.

In a preferred embodiment of the invention, the wet heat durability of the cellulose acylate film that contains a cellulose acylate having a low degree of acyl substitution as described above can be improved, and a laminate composed of the cellulose acylate film having such a low degree of acyl substitution and an adhesive layer can be produced. The laminate of the invention that contains the cellulose acylate film that contains a cellulose acylate having such a low degree of acyl substitution is free from the problem of bleeding out of additive that is inevitable when a single cellulose acylate film having a low degree of acyl substitution is kept under a wet heat condition, and in addition, the laminate is also free from the problem of additive crystal precipitation that may occur when the laminate of an adhesive layer and the cellulose acylate film is kept in a wet heat condition.

### [Production of Cellulose Acylate Film]

The production method preferably comprises a film formation step of casting a dope onto support and evaporating the solvent to form a cellulose ester film, a stretching step of stretching the film, a drying step of drying the resulting film, and, after the drying step, a step of heat treatment of the film at a temperature of from 150 to 200° C. for at least 1 minute.

### (Film Formation Step)

In the production method for the film of the invention, a known method of forming a cellulose ester film may be employed broadly. Preferred is a solvent casting method. In a solvent casting method, a solution (dope) prepared by dissolving a cellulose acylate in an organic solvent is formed into a film.

The organic solvents are preferably selected from ethers having 3-12 carbon atoms, esters having 3-12 carbon atoms, ketones having 3-12 carbon atoms and halogenated hydrocarbons having 1-6 carbon atoms. The ethers, the ketones and the esters may have a cyclic structure. Compounds having two or more functional groups of ethers, esters and ketones (i.e., —O—, —CO— and —COO—) are also usable herein as the organic solvent; and they may have any other functional group such as an alcoholic hydroxyl group. In case where the organic solvent has two or more functional groups, the number of the carbon atoms constituting them may fall within a range of the number of carbon atoms that constitute the compound having any of those functional groups.

Examples of the ethers having 3-12 carbon atoms are diisopropyl ether, dimethoxymethane, dimethoxyethane, 1,4-dioxane, 1,3-dioxolane, tetrahydrofuran, anisole and phenetole.

Examples of the ketones having 3-12 carbon atoms are acetone, methyl ethyl ketone, diethyl ketone, diisobutyl ketone, cyclohexanone, methylcyclohexanone.

Examples of the esters having 3-12 carbon atoms are ethyl formate, propyl formate, pentyl formate, methyl acetate, ethyl acetate, pentyl acetate.

Examples of the organic solvents having plural functional groups are 2-ethoxyethyl acetate, 2-methoxyethanol and 2-butoxyethanol.

The number of the carbon atoms constituting the halogenohydrocarbon is preferably 1 or 2, most preferably 1. The halogen in the halogenohydrocarbon is preferably chlorine. The proportion of the hydrogen atoms in the halogenohydrocarbon substituted with a halogen is preferably from 25 to 75 mol %, more preferably from 30 to 70 mol %, even more preferably from 35 to 65 mol %, most preferably from 40 to 60 mol %. Methylene chloride is a typical halogenohydrocarbon.

Two or more different types of organic solvents may be mixed for use in the invention.

The cellulose acylate solution may be prepared according to an ordinary method. In one general method, the solution is processed at a temperature not lower than 0° C. (room temperature or high temperature). For preparing the solution, employable is a method and an apparatus for dope preparation according to an ordinary solvent casting method. In the ordinary method, preferably used is a halogenohydrocarbon (especially methylene chloride) as the organic solvent.

The amount of the cellulose acylate is so controlled that it may be in the solution in an amount of from 10 to 40% by mass. The amount of the cellulose acylate is preferably from 10 to 30% by mass. To the organic solvent (main solvent), polymer X and any additives mentioned above can be added.

The solution is prepared by stirring a cellulose acylate and an organic solvent at room temperature (0 to 40° C.). A high-concentration solution may be stirred under pressure and under heat. Concretely, a cellulose acylate and an organic solvent are put into a pressure chamber, then closed and stirred therein and under heat at a temperature within a range between the boiling point of the solvent at room temperature and the boiling point under the pressure. The heating temperature is generally 40° C. or higher, preferably from 60 to 200° C., more preferably from 80 to 110° C.

The ingredients may be put into the chamber after roughly premixed. They may be put into the chamber one after another. The chamber must be so planned that the contents therein could be stirred. An inert gas such as nitrogen gas or the like may be introduced into the chamber to pressurize it. The solvent vapor pressure may increase under heat, and this may be utilized in process. Alternatively, after the chamber is closed, the ingredients may be introduced thereinto under pressure.

Preferably, the contents in the chamber are heated in an external heating mode. For example, a jacket type heating unit may be used. A plate heater may be disposed outside the chamber, and a liquid may be circulated through the pipeline disposed in the heater to thereby heat the entire chamber.

Also preferably, a stirring blade may be disposed inside the chamber, with which the contents may be stirred. The stirring blade preferably has a length that reaches near the wall of the chamber. At the tip of the stirring blade, a scraper is preferably provided for renewing the liquid film formed on the wall of the chamber.

The chamber may be equipped with various meters such as a pressure gauge, a thermometer, etc. In the chamber, the ingredients are dissolved in the solvent. Thus prepared, the dope is taken out of the chamber after cooled, or after taken out of it, the dope may be cooled with a heat exchanger or the like.

From the thus-prepared cellulose acylate solution (dope), a cellulose acylate laminate film can be produced according to a solvent casting method.

The dope is cast on a drum or a band, on which the solvent is evaporated away to form a film. Before case, the concentration of the dope is preferably so planned that the solid content thereof is from 18 to 35% by mass. Preferably, the surface of the drum or the band is finished to be a mirror face. The casting and drying method in solvent casting is described in U.S. Pat. Nos. 2,336,310, 2,367,603, 2,492,078, 2,492,977, 2,492,978, 2,607,704, 2,739,069, 2,739,070, British Patents 640731, 736892, JP-B 45-4554, 49-5614, JP-A 60-176834, 60-203430, 62-115035.

Preferably, the dope is cast on a drum or a band at a surface temperature of not higher than 10° C. After thus cast, preferably, this is dried by exposing to air for at least 2 seconds. The formed film is peeled away from the drum or the band, and then it may be dried with high-temperature air of which the temperature is stepwise changed from 100° C. to 160° C. to thereby remove the residual solvent by vaporization. This method is described in JP-B 5-17844. According to the method, the time to be taken from the casting to the peeling may be shortened. In carrying out the method, the dope must be gelled at the surface temperature of the drum or the band on which it is cast.

### (Additive)

Various low-molecular and high-molecular additives may be added to the cellulose ester film in the process of producing the film, in accordance with the use thereof. The additives include, for example, anti-aging agent, UV inhibitor, retardation (optical anisotropy) regulator (e.g., low-molecular Rth regulator and Re regulator except the above-mentioned polyester polyol), release promoter, plasticizer, IR absorbent, mat agent, etc. They may be solid or oily. Specifically, their melting point and boiling point are not specifically defined. For example, a UV-absorbing material having a melting point of not higher than 20° C. and a UV-absorbing material having a melting point of higher than 20° C. may be mixed; and different anti-aging agents may be mixed in the same manner. IR-absorbing dyes described in, for example, JP-A 2001-194522 may be used herein. The time of adding the additive may be at any time in the process of producing the cellulose ester solution (dope); or a step of adding an additive may be provided as the final step of the process of dope preparation. Further, the amount of the additive material is not specifically defined so far as the additive could exhibit its function. In case where the cellulose ester film is composed of multiple layers, the type and the amount of the additive to be added to each layer may differ. The additive for use in the invention is a component that is added to the cellulose ester film for the purpose of improving the functions of the film. Accordingly, impurities and residual solvents are not the additives in the invention. Examples of the additives that may be in the film of the invention are described concretely hereinunder. Not overstepping the scope and the spirit of the invention, any other known additives may be in the film with no specific limitation. For example, the additives described in JP-A 2006-64803, 2007-3767, 2007-86254 are employable here.

### (Anti-Aging Agent)

Known anti-aging agents (e.g., antioxidant, peroxide-decomposing agent, radical inhibitor, metal inactivator, acid scavenger, amine) may be added to the cellulose ester solution in the invention. Anti-aging agents are described in JP-A 3-199201, 5-197073, 5-194789, 5-271471, 6-107854. The amount of the anti-aging agent to be added is preferably from 0.01 to 1% by mass of the prepared solution (dope), more preferably from 0.01 to 0.2% by mass from the viewpoint that the added anti-aging agent could exhibit its effect and does not bleed out on the film surface. Especially preferred examples of the anti-aging agent are butylated hydroxytoluene (BHT) and tribenzylamine (TBA). The antioxidant is preferably a phenolic or hydroquinone-type antioxidant, or a phosphorus-containing antioxidant. The amount of the antioxidant to be added may be from 0.05 to 5.0 parts by mass relative to 100 parts by mass of the cellulose ester.

### (UV Absorbent)

A UV absorbent is preferably added to the cellulose ester solution in the invention for the purpose of preventing degradation of polarizers and liquid crystals. The UV absorbent is preferably one having excellent absorbability of UV rays at a wavelength of 370 nm or less but absorbing few visible light rays at a wavelength of 400 nm or more from the viewpoint of securing good liquid-crystal display capability. Especially preferably, the UV absorbent has a transmittance at a wavelength of 370 nm of at most 10%, more preferably at most 5%, even more preferably at most 2%. Specific examples of the UV absorbent preferred for use in the invention include, for example, hindered phenol compounds, oxybenzophenone compounds, benzotriazole compounds, salicylate compounds, benzophenone compounds, cyanoacrylate compounds, nickel complex salt compounds, etc., to which, however, the invention is not limited. Two or more such UV absorbents may be combined for use here. Regarding the method of adding the UV absorbent to the dope (in the invention, the cellulose ester solution for solution casting may be referred to as dope), it may be dissolved in an organic solvent such as alcohol, methylene chloride or dioxolan and then added to the dope, or it may be directly added to the dope composition. The UV absorbent of an organic powder not dissolving in an organic solvent may be dispersed in a mixture of cellulose ester and organic acid, using a dissolver or a sand mill, and then added to the dope. The amount of the UV inhibitor to be added is preferably from 1 ppm to 1.0% by mass, more preferably from 10 to 1000 ppm by mass.

### (Retardation Enhancer)

The cellulose ester film may contain a retardation enhancer. Containing a retardation enhancer, the film can attain a high Re expression at a low draw ratio in stretching. The type of the retardation enhancer is not specifically defined. The retardation enhancer includes rod-shaped or discotic compounds. The rod-shaped or discotic compounds serving as the retardation enhancer may be those having at least two aromatic rings.

The compound having at least two aromatic rings preferably expresses optically positive monoaxiality when monoaxially aligned.

The molecular weight of the compound having at least two aromatic rings is preferably from 300 to 1200, more preferably from 400 to 1000.

In case where the cellulose ester film of the invention is used as an optical compensatory film, stretching it is effective for controlling the optical properties, especially Re thereof to fall within a preferred range. For Re increase, the in-plane the refractivity anisotropy must be increased, and one method for it is comprises stretching the polymer to thereby enhance the main chain alignment of the film. Using a compound having a large refractivity anisotropy level as an additive, and adding it to the polymer film may further increase the refractivity anisotropy of the film. For example, when the above-mentioned, two or more aromatic rings-having compound is added to the polymer film and when the film is stretched, then the alignability of the compound itself may be enhanced as the force of aligning the polymer chain can be imparted to the compound by stretching and the film can be thereby controlled with ease to have desired optical characteristics.

As the compound having at least two aromatic rings, for example, there are mentioned triazine compounds described in JP-A 2003-344655, rod-shaped compounds described in JP-A 2002-363343, and liquid-crystalline compounds described in JP-A 2005-134884 and 2007-119737. Preferred are the above-mentioned triazine compounds and rod-shaped compounds.

Two or more such compounds having at least two aromatic rings may be combined for use herein.

The amount of the compound having at least two aromatic rings to be added here is preferably from 0.05% to 10% by mass relative to the cellulose ester, more preferably from 0.5% to 8%, even more preferably from 1% to 5%.

In case where the cellulose ester film of the invention is laminated with an adhesive layer to give a laminate of the invention for further enhancing the wet heat durability of the laminate, the amount of the rod-shaped compound serving as a retardation enhancer to the film is preferably from 0.5 to 10 parts by mass relative to 100 parts by mass of the cellulose ester-containing polymer component, more preferably from 2 to 6 parts by mass.

The discotic retardation enhancer is used preferably in an amount of from 0.5 to 10 parts by mass relative to 100 parts by mass of the cellulose ester-containing polymer component, more preferably from 1 to 8 parts by mass, even more preferably from 2 to 6 parts by mass.

Two or more different types of retardation enhancers may be used, as combined.

Preferably, the retardation enhancer has a maximum absorption in a wavelength range of from 250 to 400 nm, and preferably, it does not have substantial absorption in a visible light region.

Description will be given about the discotic compound. As the discotic compound, a compound having at least two aromatic rings can be employed.

In the specification, an “aromatic ring” includes an aromatic heteroring, in addition to an aromatic hydrocarbon ring.

The aromatic hydrocarbon ring is particularly preferably a 6-membered ring (that is, benzene ring). Generally, the aromatic heteroring is an unsaturated heteroring. The aromatic heteroring is preferably a 5-membered ring, 6-membered ring or a 7-membered ring, more preferably a 5-membered ring or a 6-membered ring. Generally, the aromatic heteroring has the largest number of double bonds. As hetero atoms, a nitrogen atom, an oxygen atom and a sulfur atom are preferred, and a nitrogen atom is particularly preferred. Examples of the aromatic heteroring include a furan ring, a thiophene ring, a pyrrole ring, an oxazole ring, an iso-oxazole ring, a thiazole ring, an iso-thiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, a benzene ring, a condensed benzene ring, biphenol and a 1,3,5-triazine ring are used preferably, and, in particular, a 1,3,5-triazine ring is preferably used. Specifically, compounds, for example, disclosed in JP-A-2001-166144 are used preferably as a discotic compound.

Number of aromatic rings included in the retardation enhancer is preferably 2-20, more preferably 2-12, furthermore preferably 2-8, most preferably 2-6.

Bond relation of two aromatic rings can be classified into following cases (since an aromatic ring, a spiro bond can not be formed): (a) formation of a condensed ring, (b) formation of a direct bond by a single bond, and (c) formation of a bond via a linking group. The bond relation may be any one of (a)-(c).

Examples of the (a) condensed ring (a condensed ring of two or more of aromatic rings) include an indene ring, a naphthalene ring, an azulene ring, a fluorene ring, a phenanthrene ring, an anthracene ring, an acenaphthylene ring, an biphenylene ring, a naphthacene ring, a pyrene ring, an indole ring, an iso-indole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and a thianthrene ring. A naphthalene ring, an azulene ring, an indole ring, a benzoxazole ring, a benzothiazole ring, a benzoimidazole ring, benzotriazole ring and a quinoline ring are preferred.

The single bond of (b) is preferably a carbon-carbon bond between two aromatic rings. Two aromatic rings may be bonded by two or more of single bonds to form an aliphatic ring or a non-aromatic heteroring between the two aromatic rings.

The linking group of (c) also bonds, preferably, to carbon atoms of the two aromatic rings. The linking group is preferably an alkylene group, an alkenylene group, an alkynylene group, —CO—, —O—, —NH—, —S— or combinations thereof. Examples of the linking group composed of the combination are shown below. In this connection, the relation of right and left in the following examples of linking group may be reversed.

c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the linking group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureide group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfoneamide group, an aliphatic-substituted amino group, an aliphatic-substituted carbamoyl group, an aliphatic-substituted sulfamoyl group, an aliphatic-substituted ureide group and a non-aromatic heterocyclic group.

Number of carbon atoms of the alkyl group is preferably 1-8. A chain alkyl group is preferred to a cyclic alkyl group, and a strait-chain alkyl group is particularly preferred. The alkyl group may further have a substituent (for example, a hydroxyl group, a carboxyl group, an alkoxy group, an alkyl-substituted amino group). Examples of the alkyl group (including the substituted alkyl group) include a methyl group, an ethyl group, a n-butyl group, a n-hexyl group, a 2-hydroxyethyl group, a 4-carboxybutyl group, a 2-methoxyethyl group and 2-diethylaminoethyl group.

Number of carbon atoms of the alkenyl group is preferably 2-8. A chain alkenyl group is preferred to a cyclic alkenyl group, and a straight-chain alkenyl group is particularly preferred. The alkenyl group may further have a substituent. Examples of the alkenyl group include a vinyl group, an aryl group and a 1-hexenyl group.

Number of carbon atoms of the alkynyl group is preferably 2-8. A chain alkynyl group is preferred to a cyclic alkynyl group, and a straight-chain alkynyl group is particularly preferred. The alkynyl group may further have a substituent. Examples of the alkynyl group include an ethynyl group, a 1-butynyl group and a 1-hexynyl group.

Number of carbon atoms of the aliphatic acyl group is preferably 1-10. Examples of the aliphatic acyl group include an acetyl group, a propanoyl group and a butanoyl group.

Number of carbon atoms of the aliphatic acyloxy group is preferably 1-10. Example of the aliphatic acyloxy group include an acetoxy group.

Number of carbon atoms of the alkoxy group is preferably 1-8. The alkoxy group may further have an substituent (for example, an alkoxy group). Examples of the alkoxy group (including a substituted alkoxy group) include a methoxy group, an ethoxy group, a butoxy group and a methoxyethoxy group.

Number of carbon atoms of the alkoxycarbonyl group is preferably 2-10. Examples of the alkoxycarbonyl group include a methoxycarbonyl group and an ethoxycarbonyl group.

Number of carbon atoms of the alkoxycarbonylamino group is preferably 2-10. Examples of the alkoxycarbonylamino group include a methoxycarbonylamino group and an ethoxycarbonylamino group.

Number of carbon atoms of the alkylthio group is preferably 1-12. Examples of the alkylthio group include a methylthio group, an ethylthio group and an octylthio group.

Number of carbon atoms of the alkylsulfonyl group is preferably 1-8. Examples of the alkylsulfonyl group include a methanesulfonyl group and an ethanesulfonyl group.

Number of carbon atoms of the aliphatic amide group is preferably 1-10. Example of the aliphatic amide group includes an acetamide group.

Number of carbon atoms of the aliphatic sulfonamido group is preferably 1-8. Examples of the aliphatic sulfonamido group include a methane sulfonamido group, a butane sulfonamido group and a n-octane sulfonamido group.

Number of carbon atoms of the aliphatic-substituted amino group is preferably 1-10. Examples of the aliphatic-substituted amino group include a dimethylamino group, a diethylamino group and a 2-carboxyethylamino group.

Number of carbon atoms of the aliphatic-substituted carbamoyl group is preferably 2-10. Examples of the aliphatic-substituted carbamoyl group include a methylcarbamoyl group and a diethylcarbamoyl group.

Number of carbon atoms of the aliphatic-substituted sulfamoyl group is preferably 1-8. Examples of the aliphatic-substituted sulfamoyl group include a methylsulfamoyl group and a diethylsulfamoyl group.

Number of carbon atoms of the aliphatic-substituted ureide group is preferably 2-10. Example of the aliphatic-substituted ureide group includes a methylureide group.

Examples of the non-aromatic heterocyclic group include a piperidino group and a morphorino group.

Molecular weight of the retardation enhancer composed of the discotic compound is preferably 300-800.

A compound represented by following formula (III) is preferably used for the discotic compound.

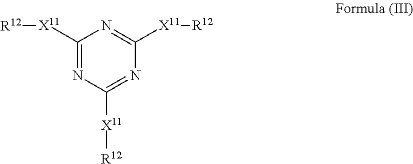

In the above formula (III):

R¹² each independently represents an aromatic ring or a hetero ring having a substituent at any of the ortho-, meta- and para-positions.

X¹¹ each independently represents a single bond or —NR¹³—. R¹³ each independently represents a hydrogen atom, or a substituted or unsubstituted alkyl, alkenyl, aryl or heterocyclic group.

The aromatic ring represented by R¹² is preferably a phenyl ring or a naphtyl ring, particularly preferably a phenyl ring. The aromatic ring represented by R¹² may have at least one substituent in any one of substitution positions. For the example of the above-mentioned substituent, a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl substituted sulfamoyl group, an alkenyl substituted sulfamoyl group, an aryl substituted sulfamoyl group, a sulfoneamide group, a carbamoyl group, an alkyl substituted carbamoyl group, an alkenyl substituted carbamoyl group, an aryl substituted carbamoyl group, an amide group, an alkylthio group, an alkenylthio group, an arylthio group and an acyl group are included.

The hetero ring for R¹² is preferably aromatic. The aromatic hetero ring is generally an unsaturated hetero ring, and is preferably a hetero ring having maximum double bonds. The hetero ring is preferably a 5-membered ring, a 6-membered ring or a 7-membered ring, more preferably a 5-membered ring or a 6-membered ring, most preferably a 5-membered ring. The hetero atom constituting the hetero ring is preferably a nitrogen atom, a sulfur atom or an oxygen atom, more preferably a nitrogen atom. The aromatic hetero ring is especially preferably a pyridine ring (as the heterocyclic group, a 2-pyridyl or 4-pyridyl group). The heterocyclic group may have a substituent. Examples of the substituent for the heterocyclic group may be the same as those mentioned hereinabove for the substituent of the aryl moiety.

The heterocyclic group in a case where X¹¹ is a single bond is preferably a heterocyclic group having a chemical bond at the nitrogen atom. The heterocyclic group having a chemical bond at the nitrogen atom is preferably a 5-membered ring, a 6-membered ring or a 7-membered ring, more preferably a 5-membered ring or a 6-membered ring, most preferably a 5-membered ring. The heterocyclic group may have plural nitrogen atoms. The heterocyclic group may have any other hetero atom (e.g., O, S) than the nitrogen atom. Examples of the heterocyclic group having a chemical bond at the nitrogen atom are shown below.

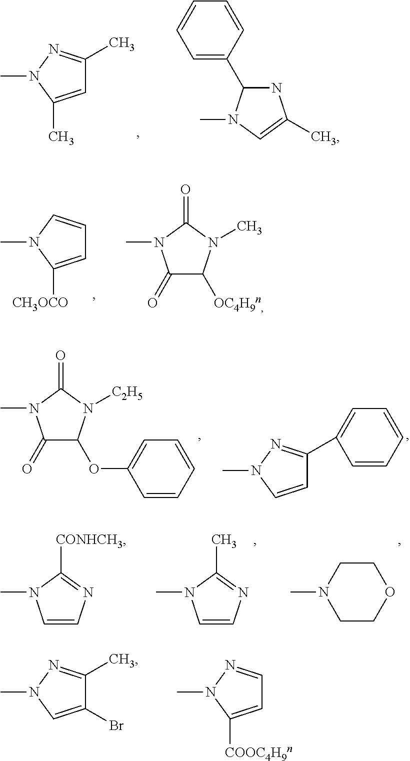

The alkyl group represented by R¹³ may be a cyclo alkyl group or a chain alkyl group, preferably a chain alkyl group. A straight chain alkyl group is more preferred to a branched chain alkyl group. Number of the carbon atoms of the alkyl group is preferably 1-30, more preferably 1-20, further preferably 1-10, further more preferably 1-8, and most preferably 1-6. The alkyl group may have a substituent. An example of the substituent includes a halogen atom, an alkoxy group (for example, a methoxy group, an ethoxy group) and an acyloxy group (for example, an acryloxy group, a metacryloxy group).

The alkenyl group represented by R¹³ may be a cyclo alkenyl group or a chain alkenyl group, preferably a chain alkenyl group. A straight chain alkenyl group is more preferred to a branched chain alkyl group. Number of the carbon atoms of the alkyl group is preferably 2-30, more preferably 2-20, further preferably 2-10, further more preferably 2-8, and most preferably 2-6. The alkenyl group may have a substituent. As the substituents, those for the above-mentioned alkyl group can be used.

The aromatic ring group and heterocyclic group represented by R¹³ and their preferable groups are as described in R¹² above. The aromatic ring group and the heterocyclic group may have a substituent further, and examples of the substituent are the same as those for R¹².

The triphenylene compounds disclosed in [0097] to [0108] of JP-A 1008-150592 can also be preferably used as an discotic compounds,

The compound represented by formula (III) can be produced by, for example, a method given in the JP-A 2003-344655 and the other compounds can be produced by, for example, a method given in JP-A 2005-134884. Both compounds may be produced by other well-known methods.

Rod-shaped compounds having a linear molecular structure are also usable preferably in addition to the discotic compound. For example, the rod-shaped compounds disclosed in [0110] to [0127] of JP-A 2008-150592.

Two kinds or more of the rod-shaped compounds, which have a maximum absorption wavelength (λmax) of less than 250 nm in an ultraviolet spectrum of the solution, may be used simultaneously.

A rod-shaped compound can be synthesized according to methods described in references. As references, Mol. Cryst. Liq. Cryst., vol. 53, p 229 (1979); do. vol. 89, p 93 (1982); do. vol. 145, p 111 (1987); do. vol. 170, p 43 (1989); Journal of the American Chemical Society, vol. 113, p 1349 (1991); do. vol. 118, p 5346 (1996); do. vol. 92, p 1582 (1970); Journal of Organic Chemistry, vol. 40, p 420 (1975); and Tetrahedron, vol. 48, No. 16, p 3437 (1992) can be mentioned.

### (Release Promoter)

Many surfactants are noticeably effective as an additive for reducing the release resistance of cellulose ester film. Phosphate ester-type surfactants, carboxylic acid-type or carboxylic acid salt-type surfactants, sulfonic acid-type or sulfonic acid salt-type surfactants, and sulfate ester-type surfactants are effective and are preferred as a release agent. Fluorine-containing surfactants produced by substituting a part of the hydrogen atoms bonding to the hydrocarbon chain in the above-mentioned surfactants with fluorine atoms are also effective.

The amount of the release agent to be added is preferably from 0.05 to 5% by mass of the cellulose ester, more preferably from 0.1 to 2% by mass, most preferably from 0.1 to 0.5% by mass.

In case where the cellulose ester film of the invention is laminated with an adhesive layer to give a laminate of the invention for further enhancing the wet heat durability of the laminate, the release promoter may be in the film in an amount of, for example, from 0.001 to 1% by weight. As the release promoter, the compounds described in JP-A 2006-45497, paragraphs [0048]-[0069] are preferably used here.

### (Plasticizer)

Cellulose ester film is generally poorly flexible as compared with cellulose acetate, and therefore when bending stress or shearing stress is applied thereto, the film is often cracked. In addition, in case where the film is worked into an optical film, the cut section is often cracked and often forms chip. The formed chip contaminates the optical film, therefore causing optical defects. To solve these problems, to improve the mechanical properties of the film and to increase the drying speed, a plasticizer may be added to the cellulose ester film.

Concretely, there are mentioned phthalate compounds, trimellitate compounds, aliphatic dibasic acid ester compounds, orthophosphate compounds, acetate compounds, polyester/epoxidated ester compounds, ricinoleate compounds, polyolefin compounds, and polyethylene glycol compounds.

The plasticizer for use herein is preferably selected from compounds that are liquid at room temperature and under normal pressure and have a boiling point of not lower than 200° C. Concrete compounds are aliphatic dibasic acid ester compounds, phthalate compounds, and polyolefin compounds.

The amount of the plasticizer to be added may be from 0.5 to 40.0% by mass relative to the cellulose ester resin, preferably from 1.0% by mass to 30.0% by mass, more preferably from 3.0% by mass to 20.0% by mass. When the amount of the plasticizer added is smaller than the range, the plasticizing effect thereof may be insufficient and the workability of the ester composition could be bettered. However, when the amount is larger than the range, it is unfavorable since the plasticizer may separate and dissolve out with a lapse of long time therefore causing optical unevenness and contamination of other parts.

When the cellulose ester film of the invention is used in the laminate of the invention, phosphates or carboxylates are usable as the plasticizer. Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetylcitrate (OACTE) and tributyl O-acetylcitrate (OACTB). Examples of other carboxylates include butyl oleate, methylacetyl ricinoleate, dibutyl sebacate, and various trimellitates. Preferred for use herein are phthalate plasticizers (DMP, DEP, DBP, DOP, DPP, DEHP). More preferred are DEP and DPP. The plasticizer is preferably added in an amount of from 0.1 to 25% by weight, more preferably from 1 to 20% by weight, most preferably from 3 to 15% by weight of the amount of the cellulose ester.

### (Low-Molecular Rth Regulator Except the Above-Mentioned Polyester Polyol)

The cellulose ester film may contain any other low-molecular Rth regulator than the above-mentioned polyester polyol, for example, in an amount of from 5 to 25% by weight, preferably from 10 to 20% by weight. Containing the Rth regulator, the film, after stretched, may have a high Re and a low Rth, therefore having a low Nz factor (Nz=Rth/Re+0.5). The Rth regulator may be any known one, not overstepping the spirit and the scope of the invention. For example, there are mentioned ester plasticizers, and preferably mentioned are those that are more hydrophobic than cellulose ester, for example, phosphate ester plasticizers such as triphenyl phosphate (TPP), tricresyl phosphate, cresyldiphenyl phosphate, octyldiphenyl phosphate, diphenylbiphenyl phosphate, trioctyl phosphate, tributyl phosphate, and butylphenyldiphenyl phosphate (BDP); phthalate ester plasticizers such as diethyl phthalate, dimethylethyl phthalate, dimethyl phthalate, dioctyl phthalate, dibutyl phthalate, and di-2-ethylhexyl phthalate; glycolate ester plasticizers such as triacetin, tributyrin, butylphthalylbutyl glycolate, ethylphtyalylethyl glycolate, methylphthalylethyl glycolate, and butylphthalylbutyl glycolate; and preferably, one or more of these may be used either singly or as combined. If desired, two or more different types of these plasticizers may be used here as combined.

### (High-Molecular Additive)

High-molecular additives to be mentioned below may be added to the film of the invention. Preferred are compounds having a recurring unit therein and having a number-average molecular weight of from 700 to 10000. The high-molecular additive is used for increasing the vaporization speed of the solvent and for reducing the residual solvent amount in a solution casting method of producing the film of the invention.

The number-average molecular eight of the high-molecular additive for use in the invention is preferably from 700 to less than 10000, more preferably from 800 to 8000, even more preferably from 800 to 5000, still more preferably from 1000 to 5000. Having the molecular weight falling within the above range, the additive may have better miscibility with other ingredients.

### Polymer Additive Except Polyester Polymer:

The polymer additive is selected from styrenic polymers, acrylic polymers and their copolymers; and preferred are aliphatic polyesters, aromatic polyesters, acrylic polymers and styrenic polymers.

### Styrenic Polymer:

The styrenic polymer preferably has a structural unit derived from an aromatic vinyl monomer, as represented by the following general formula (I):

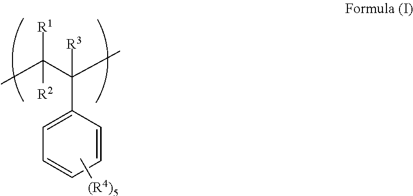

In the formula, R¹ to R⁴ each independently represent a hydrogen atom, a halogen atom, or a substituted or unsubstituted hydrocarbon group having from 1 to 30 carbon atoms or a polar group, which may have a linking group containing an oxygen atom, a sulfur atom, a nitrogen atom or a silicon atom; R⁴'s may be all the same atoms or groups or may be different atoms or groups, or may bond to each other to form a carbon ring or a hetero ring (the carbon ring and the hetero ring may have a monocyclic structure or a polycyclic structure condensed with any other ring).

Specific examples of the aromatic vinyl monomer include styrene; alkyl-substituted styrenes such as α-methylstyrene, β-methylstyrene, p-methylstyrene; halogen-substituted styrenes such as 4-chlorostyrene, 4-bromostyrene; hydroxystyrenes such as p-hydroxystyrene, a-methyl-p-hydroxystyrene, 2-methyl-4-hydroxystyrene, 3,4-dihydroxystyrene; vinylbenzyl alcohols; alkoxy-substituted styrenes such as p-methoxystyrene, p-tert-butoxystyrene, m-tert-butoxystyrene; vinylbenzoic acids such as 3-vinylbenzoic acid, 4-vinylbenzoic acid; vinylbenzoates such as methyl 4-vinylbenzoate, ethyl 4-vinylbenzoate; 4-vinylbenzyl acetate; 4-acetoxystyrene; amidestyrenes such as 2-butylamidestyrene, 4-methylamidestyrene, p-sulfonamidestyrene; aminostyrenes such as 3-aminostyrene, 4-aminostyrene, 2-isopropenylaniline, vinylbenzyldimethylamine; nitrostyrenes such as 3-nitrostyrene, 4-nitrostyrene; cyanostyrenes such as 3-cyanostyrene, 4-cyanostyrene; vinylphenylacetonitrile; arylstyrenes such as phenylstyrene; indenes, etc. However, the invention should not be limited to these examples. Two or more such monomers may be used as comonomers. Of those, preferred are styrene and α-methylstyrene as industrially available and inexpensive.

### Acrylic Polymer:

The acrylic polymer preferably has a structural unit derived from an acrylate monomer, as represented by the following general formula (II):

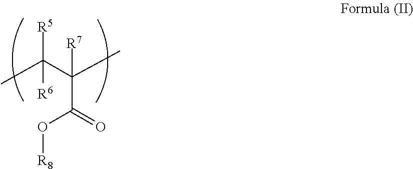

In the formula, R⁵ to R⁸ each independently represent a hydrogen atom, a halogen atom, or a substituted or unsubstituted hydrocarbon group having from 1 to 30 carbon atoms or a polar group, which may have a linking group containing an oxygen atom, a sulfur atom, a nitrogen atom or a silicon atom.

Examples of the acrylate monomer include, for example, methyl acrylate, ethyl acrylate, propyl (i-, n-) acrylate, butyl (n-, s-, tert-) acrylate, pentyl (n-, s-) acrylate, hexyl (n-, i-) acrylate, heptyl (n-, i-) acrylate, octyl (n-, i-) acrylate, nonyl (n-, i-) acrylate, myristyl (n-, i-) acrylate, (2-ethylhexyl)acrylate, (s-caprolactone) acrylate, (2-hydroxyethyl)acrylate, (2-hydroxypropyl)acrylate, (3-hydroxypropyl)acrylate, (4-hydroxypropyl)arylate, (2-hydroxybutyl)acrylate, (2-methoxyethyl)acrylate, (2-ethoxyethyl)acrylate, phenyl acrylate, phenyl methacrylate, (2- or 4-chlorophenyl)acrylate, (2- or 4-chlorophenyl)methacrylate, (2-, 3- or 4-ethoxycarbonylphenyl)acrylate, (2-, 3- or 4-ethoxycarbonylphenyl)methacrylate, (o-, m- or p-tolyl) acrylate, (o-, m- or p-tolyl) methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate; as well as methacrylates corresponding to the above acrylates. However, the invention should not be limited to these examples. Two or more such monomers may be used as comonomers. Of those, preferred are methyl acrylate, ethyl acrylate, propyl (i-, n-) acrylate, butyl (n-, i-, s-, tert-) acrylate, pentyl (n-, i-, s-) acrylate, hexyl (n-, i-) acrylate, and methacrylates corresponding to the these acrylates, as industrially available and inexpensive.

### Copolymer:

The copolymer preferably has at least one structural unit derived from an aromatic vinyl monomer represented by the following general formula (I) and an acrylate monomer represented by the following general formula (II):

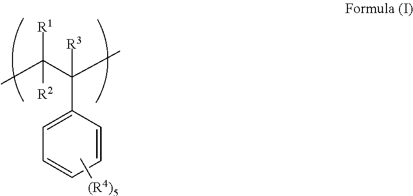

In the formula, R¹ to R⁴ each independently represent a hydrogen atom, a halogen atom, or a substituted or unsubstituted hydrocarbon group having from 1 to 30 carbon atoms or a polar group, which may have a linking group containing an oxygen atom, a sulfur atom, a nitrogen atom or a silicon atom; R⁴'s may be all the same atoms or groups or may be different atoms or groups, or may bond to each other to form a carbon ring or a hetero ring (the carbon ring and the hetero ring may have a monocyclic structure or a polycyclic structure condensed with any other ring).

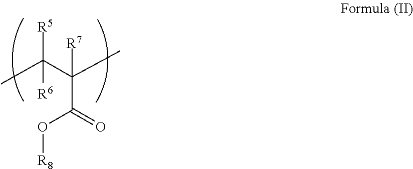

In the formula, R⁵ to R⁸ each independently represent a hydrogen atom, a halogen atom, or a substituted or unsubstituted hydrocarbon group having from 1 to 30 carbon atoms or a polar group, which may have a linking group containing an oxygen atom, a sulfur atom, a nitrogen atom or a silicon atom.

The other structure than the above to constitute the copolymer composition is preferably one excellent in copolymerizability with the above-mentioned monomers, and its examples include acid anhydrides such as maleic anhydride, citraconic anhydride, cis-1-cyclohexene-1,2-dicarboxylic acid anhydride, 3-methyl-cis-1-cyclohexene-1,2-dicarboxylic acid anhydride, 4-methyl-cis-1-cyclohexene-1,2-dicarboxylic acid anhydride; nitrile group-having radical-polymerizing monomers such as acrylonitrile, methacrylonitrile; amide bond-having radical-polymerizing monomers such as acrylamide, methacrylamide, trifluoromethanesulfonylaminoethyl (meth)acrylate; fatty acid vinyl esters such as vinyl acetate; chlorine-containing radical-polymerizing monomers such as vinyl chloride, vinylidene chloride; conjugated diolefins such as 1,3-butadiene, isoprene, 1,4-dimethylbutadiene. However, the invention should not be limited to these examples. Of those, especially preferred are styrene/acrylic acid copolymer, styrene/maleic anhydride copolymer, and styrene/acrylonitrile copolymer.

### (Mat Agent Fine Particles)

Preferably, the cellulose ester film of the invention contains fine particles serving as a mat agent. As the fine particles for use in the invention, there may be mentioned silicon dioxide, titanium dioxide, aluminium oxide, zirconium oxide, calcium carbonate, talc, clay, calcined kaolin, calcined calcium silicate, hydrated calcium silicate, aluminium silicate, magnesium silicate, and calcium phosphate. Fine particles containing silicon are preferred, as the haze of the film containing them may be low, and silicon dioxide is more preferred. Preferably, the fine particles of silicon dioxide have a primary mean particle size of at most 20 nm, and an apparent specific gravity of at least 70 g/L. More preferred are those having a small primary mean particle size of from 5 to 16 nm as the haze of the film containing them could be lower. The apparent specific gravity is preferably from 90 to 200 g/L, more preferably from 100 to 200 g/L. Those having a larger apparent specific gravity may form a dispersion having a higher concentration, and are therefore preferred since the haze of the film containing them may be low and since few aggregates are formed in the film.

The fine particles generally form secondary particles having a mean particle size of from 0.1 to 3.0 μm, and the fine particles exist as aggregates of the primary particles in the film, therefore forming fine projections of from 0.1 to 3.0 μm in height in the film surface. Preferably, the mean particle size of the secondary particles is from 0.2 μm to 1.5 μm, more preferably from 0.4 μm to 1.2 μm, most preferably from 0.6 μm to 1.1 μm. The particle size of the primary and secondary particles are determined as follows: Using a scanning electronic microscope, the particles in the film are observed, and the diameter of the circumscribing circle of each particle is taken as the particle size. At different sites, 200 particles are randomly observed, and their data are averaged to be the mean particle size.

As the fine particles of silicon dioxide, for example, usable are commercial products of Aerosil R972, R972V, R974, R812, 200, 200V, 300, R202, OX50 and TT600 (all by Nippon Aerosil). Fine particles of zirconium oxide are sold on the market as trade names of Aerosil R976 and R811 (by Nippon Aerosil), and these can be used here.

Of those, Aerosil 200V and Aerosil R972V are fine particles of silicon dioxide having a primary mean particle size of at most 20 nm and an apparent specific gravity of at least 70 g/liter, and are especially preferred for use herein as capable of keeping the haze of the optical film low and effective for reducing the friction factor of the film.

For obtaining a film containing fine particles having a small secondary mean particle size, some methods may be taken into consideration for preparing a dispersion of the fine particles. For example, herein employable is a method of previously preparing a fine particles dispersion where a solvent and fine particles are stirred and mixed, adding the fine particles dispersion to a small amount of a cellulose ester solution separately prepared, and stirring it, and further mixing it with a main cellulose ester dope solution. This method is a preferred preparation method since the silicon dioxide fine particles are well dispersible and since the silicon dioxide fine particles hardly reaggregate. Another method employable here comprises adding a small amount of cellulose ester to a solvent, stirring and dissolving it, then adding thereto fine particles and dispersing them with a disperser to prepare a fine particle additive dispersion, and well mixing the fine particle additive dispersion with a dope solution with an in-line mixer. However, the invention is not limited to these methods. When silicon dioxide fine particles are mixed and dispersed in a solvent, the concentration of silicon dioxide is preferably from 5 to 30% by mass, more preferably from 10 to 25% by mass, most preferably from 15 to 20% by mass. When the dispersion concentration is higher, then the liquid turbidity relative to the added amount may be lower, and therefore the dispersion concentration is preferably higher since the haze of the film may be lower and the film has few aggregates. The amount of the mat agent in the final cellulose ester dope solution is preferably from 0.01 to 1.0 g per m² of the film to be formed, more preferably from 0.03 to 0.3 g, most preferably from 0.08 to 0.16 g.

The solvent for use here may be a lower alcohol, preferably methyl alcohol, ethyl alcohol, propyl alcohol, isopropyl alcohol or butyl alcohol. The other solvent than lower alcohol is not specifically defined. Preferably, the solvent for use in formation of cellulose ester film is used here.

Preferred embodiments are described in detail in Disclosure Bulletin by Hatsumei Kyokai (No. 2001-1745, published on Mar. 15, 2001 by Hatsumei Kyokai) pp. 35-36, and are preferably referred to for the cellulose ester film of the invention.

### (Co-Casting)

Preferably, the cellulose ester film of the invention is produced according to a solution casting method and then stretched. Preferably, the solution cast film is a multilayer cast film produced through simultaneous or successive co-casting. This is because the film may have a desired retardation level.

In the invention, the prepared cellulose ester solution may be cast onto a smooth band or drum serving as a metal support, as a single-layer solution; or plural cellulose ester solutions for two or more layers may be co-cast thereon. In case where plural cellulose ester solutions are co-cast, the cellulose ester-containing solution may be cast onto a metal support through plural casting mouths disposed around the support at intervals in the machine direction, and the co-cast solutions may be laminated on the support to give a film. For example, the methods described in JP-A 61-158414, 1-122419, 11-198285 are employable. The cellulose ester solution may be cast through two casting mouths to form a film, for which, for example, employable are the methods described in JP-B 60-27562, JP-A 61-94724, 61-947245, 61-104813, 61-158413, 6-134933. Also employable herein is a cellulose ester film co-casting method of casting a flow of a high-viscosity cellulose ester solution as enveloped with a low-viscosity cellulose ester solution thereby simultaneously extruding both the high-viscosity and low-viscosity cellulose ester solutions, as in JP-A 56-162617. Preferred is an embodiment where the outer solution contains a larger amount of a poor solvent, alcohol than in the inner solution, as in JP-A 61-94724, 61-94725.

Two casting mouths may be used as follows: A film is formed on a metal support through the first casting mouth, then this is peeled, and on the other surface of the film opposite to that having been kept in contact with the metal support, another film is formed through the second casting mouth. For example, the method is described in JP-B 44-20235. The cellulose ester solutions to be cast may be the same or different with no specific limitation. In order to make the plural cellulose ester layers have various functions, cellulose ester solutions corresponding to the desired functions may be cast through the respective casting mouths. The cellulose ester solution in the invention may be cast along with any other functional layers (e.g., adhesive layer, dye layer, antistatic layer, antihalation layer, UV absorbent layer, polarizing layer).

In case where a single-layer film is formed according to a conventional technique, a high-concentration and high-viscosity cellulose ester solution must be extruded out in order to make the formed film have a desired thickness; but in such a case, the stability of the cellulose ester solution is poor therefore causing various problems of solid deposition to be fish eyes or to roughen the surface of the film. For solving the problems, plural cellulose ester solutions are cast out through different casting mouths, whereby high-density solutions can be extruded out at the same time on a metal support, and as a result, the surface properties of the formed films are bettered and films having excellent surface properties can be produced. In addition, since such thick cellulose ester solutions can be used and the drying load in the process can be reduced, and the film producibility is enhanced.

In co-casting, the thickness of the outer layer and the inner layer is not specifically defined. Preferably, the thickness of the outer layer is from 1 to 50% of the overall thickness of the film, more preferably from 2 to 30%. In co-casting of three or more layers, the total thickness of the layer adjacent to the metal support and the outermost layer adjacent to air is defined to be the thickness of the outer layer.

Cellulose ester solutions in which the individual cellulose esters each have a different degree of substitution may be co-cast to form a laminate-structured cellulose ester film. For example, a cellulose ester film having a constitution of TAC layer/DAC layer/TAC layer can be formed, and a cellulose ester film having a constitution of DAC layer/TAC layer/DAC layer can be formed. Cellulose ester solutions differ in point of the additive concentration of plasticizer, UV absorbent, mat agent and the like may be co-cast to produce a laminate-structured cellulose ester film. For example, the amount of the mat agent may be made large in the surface layer, or the mat agent may be made to exist only in the surface layer. The amount of the plasticizer and the UV absorbent may be made larger in the inner layer than in the surface layer, or they may be made to exist only in the inner layer. The type of the plasticizer and the UV absorbent may be made to differ between the inner layer and the surface layer. For example, a low-volatile plasticizer and/or UV absorbent may be made to exist in the surface layer, and a high-power plasticizer or a high-power UV absorbent may be added to the inner layer. Adding a release agent to the surface layer on the side of the metal support is also a preferred embodiment. For gelling the solution by cooling it on a metal support in a cooling drum method, adding a larger amount of a poor solvent, alcohol to the surface layer than to the inner layer is also preferred. Tg may differ between the surface layer and the inner layer; and preferably, Tg of the inner layer is lower than Tg of the surface layer. The viscosity of the cellulose ester-containing solution to be cast may differ between the surface layer and the inner layer; and preferably, the viscosity of the solution for the surface layer is smaller than that of the solution for the inner layer, but the viscosity of the solution for the inner layer may be lower than that of the solution for the surface layer.

### (Drying Step, Stretching Step)

A drying method for the web (film) formed and dried on a drum or a belt and peeled therefrom is described. The web peeled at a peeling position just before the drum or the belt has made one complete revolution is conveyed according to a method of alternately leading it through rolls arranged like a hound's tooth-like configuration, or according to a noncontact method of conveying it by holding both edges thereof with clips or the like. The web is dried according to a method of applying air at a predetermined temperature onto both surfaces of the traveling web, or according to a method of heating the web with microwaves or the like. Rapid drying may detract from the surface smoothness of the film being formed, and therefore in the initial stage of drying, the web is preferably dried at a temperature at which the solvent may not vaporize, and then, after the web is dried in some degree, it is preferably dried at a high temperature. In the drying step after the web is peeled from the support, the web (film) shrinks in the machine direction or in the cross direction owing to solvent evaporation. The shrinkage may be larger in drying at a higher temperature. Preferably, the web is dried with retarding the shrinkage as much as possible in order to make the finished film have good surface smoothness. From this viewpoint, for example, as in JP-A 62-46625, preferred is a method of drying the web with holding both edges thereof with clips or pins so as to keep the width of the web constant during a part or all of the drying step (tenter system). The drying temperature in the drying step is preferably from 100 to 145° C. Depending on the solvent to be used, the drying temperature, the drying air flow level and the drying temperature may vary; but in accordance with the type of the solvent used and with the combination of the solvents, the drying temperature may be suitably set. In film production in the invention, preferably, the web (film) peeled from the support is stretched while the residual solvent amount in the web is less than 120% by mass.

The residual solvent amount may be expressed by the following formula:

Residual Solvent Amount (mas. %)={(M−N)/N}×100

wherein M indicates the mass of the web at an arbitrary time, and N indicates the mass of the web dried at 110° C. for 3 hours after its mass M is measured.

When the residual solvent amount in the web is too large, the stretched web could not enjoy the stretching effect; but when too small, stretching the web may be extremely difficult and the web may be broken while stretched. More preferably, the residual solvent amount in the web is at most 70% by mass, even more preferably from 10% by mass to 50% by mass, still more preferably from 12% by mass to 35% by mass. When the draw ratio in stretching is too small, the resulting film could not have a sufficient retardation; but when too large, stretching the web may be extremely difficult and the web may be broken while stretched.

The draw ratio in stretching is preferably from 1.05 to 1.5, more preferably from 1.15 to 1.4.

The stretching may be in the machine direction or in the cross direction, or in both directions, but is preferably at least in the machine direction. The cellulose ester film of the invention is produced by stretching in the cross direction, and preferably, the draw ratio in stretching is from 5% to 100% in the direction perpendicular to the machine direction. When the draw ratio in stretching is at least 5%, then the stretched film could enjoy more suitable Re expression, and may be free from a problem of bowing. When the draw ratio is at most 50%, then the haze of the film may be low.

In the invention, the solution-cast film may be stretched even though it is not heated at a high temperature so far as its residual solvent amount falls within a specific range; however, stretching combined with drying is preferred as the working step may be shortened. However, when the web temperature is too high, then the plasticizer may evaporate, and therefore, the temperature is preferably within a range of from room temperature (15° C.) to 145° C. Biaxial stretching in two directions perpendicular to each other is effective for making the refractive index, Nx, Ny and Nz of the film fall within the range in the invention. For example, in case where the film is stretched in the casting direction (machine direction) and when the film is shrunk in the cross direction too much in the case, Nz of the resulting film may be too large. In this case, the problem may be solved by decreasing the cross-direction shrinkage of the film, or by stretching the film in the cross direction. In case where the film is stretched in the cross direction, the resulting film may have refractivity distribution in the cross direction. This is often seen in a tenter method. As the film is stretched in the cross direction, the center part of the film is given a shrinking force, but the edges of the film are kept fixed. This is referred to as a bowing phenomenon. Even in such a case, the film may be stretched in the casting direction (machine direction) to retard the bowing phenomenon, and the retardation distribution in the cross direction of the film may be reduced. Further, the film may be stretched in two directions perpendicular to each other, whereby the film thickness fluctuation may be reduced. If an optical film has too much thickness fluctuation, it may cause retardation fluctuation. The thickness fluctuation of an optical film is preferably within a range of ±3%, more preferably within a range of ±1%. From the viewpoint as above, the method of stretching the film in two directions perpendicular to each other is effective in the invention, and the draw ratio in stretching in two directions perpendicular to each other is preferably within a range of from 1.2 to 2.0 times and from 0.7 to 1.0 time, respectively. In this, stretching in one direction in a draw ratio falling within a range of from 1.2 to 2.0 times and stretching in the other perpendicular direction in a draw ratio falling within a range of from 0.7 to 1.0 time means that the distance between the clips or pins that hold the film in stretching is made to be from 0.7 to 1.0 time relative to the distance therebetween before the stretching.

In general, in case where a film is stretched in the cross direction by from 1.2 to 2.0 times, using a biaxial stretching tenter, the film receives a force to shrink it in the perpendicular direction that is the machine direction.

Accordingly, when a film is continuously stretched by imparting thereto a force only on one direction, then its width in the perpendicular direction shrinks, and the above means a case where the shrinking amount is controlled as opposed to the case with no width control in shrinking, or that is, the distance between the clips or pins for width control is defined to fall within a range of from 0.7 to 1.0 time based on the width before stretching. In this, the film is given a force to shrink it in the machine direction owing to the force for shrinking in the cross direction. Taking the distance between the clips or the pins in the machine direction makes it possible not to give any unnecessary tension to the film in the machine direction. The method of stretching the web is not specifically defined. For example, there may be mentioned a method of using plural rolls each having a different circumferential speed and stretching a web in the machine direction between the rolls based on the difference in the circumferential speed therebetween; a method of holding both edges of a web with clips or pins and stretching the web in the machine direction by broadening the distance between the adjacent clips or pins in the machine direction, or a method of stretching the web in the cross direction by broadening the distance in the same manner but in the cross direction, or a method of stretching the web both in the machine direction and in the cross direction by broadening the distance in the same manner but in both the two directions. Needless-to-say, these methods may be combined. In the tenter method, the clip parts are preferably driven according to a linear drive system since the film can be smoothly stretched with little risk of breakage.

Preferably, the cellulose ester film is stretched, more preferably in-line stretched in an integrated system for film formation. If desired, however, the formed film may be once wound up and may be stretched in an additional step. Further, if desired, the in-line stretched film may be once wound up and may be further stretched in an additional step. Stretching in that manner provides a film having a low haze and a film having a low ratio of Re/Rth.

### (Heat Treatment Step)

In the film production method of the invention, preferably, the drying step is followed by a heat treatment step. In the heat treatment step, the film may be heat-treated after the drying step. Briefly, the film may be heat-treated just after the stretching/drying step; or after once wound up after the drying step, the film may be heat-treated in an additional heat treatment step. Preferably, in the invention, the film is once wound up after the drying step, then cooled to room temperature to 100° C. or lower, and again heat-treated in an additional heat treatment step. This embodiment is advantageous in producing a film more excellent in thermal dimensional stability. For the same reason, preferably, the film is dried just before the heat treatment step to such a degree that the residual solvent amount therein is less than 2% by mass, more preferably less than 0.4% by mass.

Though not clear, the reason why the film shrinkage can be reduced by such treatment could be presumed as follows: The film stretched in the stretching step may have a large residual stress in the stretching direction and the residual stress could be canceled by the heat treatment and, as a result, the shrinking force of the film in the temperature region not higher than the heat treatment temperature could be reduced.

The heat treatment may be attained according to a method of applying air at a predetermined temperature to the traveling film, or a method of employing a heating means by microwaves or the like.

Preferably, the heat treatment temperature is from 150 to 200° C., more preferably from 160 to 180° C. Preferably, the heat treatment time is from 1 to 20 minutes, more preferably from 5 to 10 minutes.

When the film is heat-treated at a temperature higher than 200° C. for a long period of time, then the scattering amount of the plasticizer in the film may increase and this is problematic.

In the heat treatment step, the film shrinks in the machine direction or in the cross direction. Preferably, the shrinkage is inhibited as much as possible during the heat treatment and the smoothness of the finished film is bettered. For this, preferred is a method holding both edges of the web with clips or pins in the cross direction during the heat treatment (tenter system). Also preferably, the film is stretched by from 0.9 times to 1.5 times in the cross direction and in the machine direction during the heat treatment.

For winding up the produced film, an ordinary winder may be used, and the film may be wound up according to an ordinary winding method of a constant tension method, a constant torque method, a taper tension method or a programmed tension control method where the internal stress is kept constant. The optical film roll obtained in the manner as above is preferably such that the slow axis direction of the film is at ±2 degrees to the winding direction (machine direction of the film), more preferably at ±1 degree. Also preferably, the slow axis direction of the film is at ±2 degrees to the direction perpendicular to the winding direction (cross direction of the film), more preferably at ±1 degree. Even more preferably, the slow axis direction of the film is at ±0.1 degrees to the winding direction (machine direction of the film), or it is at ±0.1 degrees to the cross direction of the film.

### [Hot Steam Treatment]

If desired, the stretched film may be processed in a step of spraying thereto hot steam at 100° C. or higher. The steam spraying step is preferred, in which the residual stress in the cellulose ester film may be relaxed and the dimension change of the film may be thereby reduced. Not specifically defined, the steam temperature may be 100° C. or higher. However, in consideration of the heat resistance of the film, the steam temperature is not higher than 200° C.

The process from casting to drying may be attained in an air atmosphere or in an inert gas atmosphere such as nitrogen gas. The winder for use in producing the cellulose ester film of the invention may be any ordinary one, and the film may be wound up according to a winding method of a constant tension method, a constant torque method, a taper tension method, or a programmed tension control method where the internal stress is kept constant.

### [Surface Treatment of Cellulose Ester Film]

Preferably, the cellulose ester film is surface-treated. Concrete methods for the treatment include corona discharge treatment, glow discharge treatment, flame treatment, acid treatment, alkali treatment or UV irradiation treatment. As in JP-A 7-333433, an undercoat layer may be provided favorably on the film.

From the viewpoint of securing the surface smoothness thereof, the cellulose ester film is preferably kept at a temperature not higher than its Tg (glass transition temperature) during the treatment, concretely at 150° C. or lower.

In case where the film is used as a transparent protective film for polarizer, especially preferably the film is acid-processed or alkali-processed for saponification of the cellulose ester therein, from the viewpoint of the adhesiveness of the film to the polarizing element.

The surface energy is at least 55 mN/m, more preferably from 60 mN/m to 75 mN/m.

As one example of the treatment, alkali saponification is described concretely hereinunder.

The alkali saponification of the cellulose ester film is preferably in a cycle of dipping the film surface in an alkali solution, neutralizing it in an acid solution, then rinsing it with water and drying it.

The alkali solution includes a potassium hydroxide solution and a sodium hydroxide solution, in which the hydroxyl ion concentration is preferably within a range of from 0.1 to 3.0 mol/liter, more preferably from 0.5 to 2.0 mol/liter. The alkali solution temperature is preferably within a range of from room temperature to 90° C., more preferably within a range of from 40 to 70° C.

The surface energy of solid may be determined according to a contact angle method, a wet heat method or an adsorption method as in “Basis and Application of Wetting” (by Realize, issued on Dec. 10, 1989). A contact angle method is preferred for the cellulose ester film of the invention.

Concretely, two types of solutions both having a known surface energy value are dropped onto the cellulose ester film, and at the intersection point between the droplet surface and the film surface, the angle between the tangential line drawn to the droplet and the film surface and adjacent to the droplet is defined as the contact angle. The surface energy of the film can be determined through computation of the data.

### (Film Thickness)

Preferably, the thickness of the cellulose ester film of the invention is from 20 μm to 180 μm, more preferably from 20 μm to 100 μm, even more preferably from 20 μm to 80 μm. When the film thickness is at least 20 μm, then the film is preferred in that it may be well handled in working it to produce a polarizer and that the resulting polarizer is prevented from curling. In case where the cellulose ester film of the invention is laminated with an adhesive layer to give a laminate of the invention for further enhancing the wet heat durability of the laminate, the thickness of the cellulose ester film may be suitably determined depending on the type of the polarizer to be produced with it, but is preferably from 30 to 100 μm, more preferably from 40 to 80 μm. The thickness of the film is preferably at most 60 μm for reducing the cost of the film. Preferably, the thickness unevenness of the cellulose ester film of the invention is from 0 to 2% both in the machine direction and in the cross direction, more preferably from 0 to 1.5%, even more preferably from 0 to 1%.

Re(λ) and Rth(λ) represent, herein, the retardation in the plane and the retardation in the thickness direction, respectively, at a wavelength of λ. Re(λ) is measured with KOBRA 21ADH or WR (by Oji Scientific Instruments) while allowing light having the wavelength of λ nm to enter in the normal direction of a film. With the in-plane slow axis (determined by KOBRA 21ADH or WR) taken as the inclination axis (rotation axis) of the sample, Re(λ) of the sample is determined by calculation with KOBRA 21ADH from three retardations measured from different angles, i.e. the above Re, a retardation measured by applying a light having a wavelength of λ nm from the inclined direction of +40° relative to the normal line direction of the sample, and a retardation measured by applying a light having a wavelength of λ nm from the inclined direction of −40° relative to the normal line direction of the sample. With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (A) and (B). The mean refractive index may be used values described in catalogs for various types of optical films. When the mean refractive index has not known, it may be measured with Abbe refractometer. The mean refractive index for major optical film is described below: cellulose acylate (1.48), cycloolefin polymer (1.52), polycarbonate (1.59), polymethylmethacrylate (1.49), polystyrene (1.59). By inputting the value of these average refraction indices and thickness, KOBRA 21ADH or WR computes nx, ny, nz. From the computed nx, ny, nz, Nz=(nx−nz)/(nx−ny) is computed further.

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{( - θ )}{nx} ) )} \qquad ( A )$$

The above Re(θ) represents the retardation in a direction that inclines in the degree of θ from the normal direction; and d is a thickness of the film.

Rth={(nx+ny)/2−nz}×d (B)

In this, the mean refractive index n is needed as a parameter, and it is measured with an Abbe refractiometer (Atago's Abbe Refractiometer 2-T).

The cellulose ester film of the invention is favorably used as a protective film for polarizer, and is also favorably used as a retardation film applicable to various liquid-crystal modes. The retardation film of the invention comprises the cellulose ester film of the invention.

In case where the cellulose ester film of the invention is used as a retardation film, its Re measured at 590 nm is preferably from 30 to 200 nm, more preferably from 30 to 150 nm, even more preferably from 40 to 100 nm, and its Rth is preferably from 70 to 400 nm, more preferably from 100 to 300 nm, even more preferably from 100 to 250 nm.

Preferably, the cellulose ester film of the invention satisfies the following formula (1) and formula (2):

25 nm≦|Re(590)|≦100 nm, (1)

50 nm≦|Rth(590)|≦250 nm, (2)

wherein Re(590) and Rth(590) each mean the in-plane retardation and the thickness-direction retardation of the film as measured with a light having a wavelength of 590 nm at 25° C. and 60% RH.

More preferably, the film satisfies the following formula (1′) and formula (2′):

40 nm≦|Re(590)|≦100 nm, (1′)

100 nm≦|Rth(590)|≦250 nm. (2′)

Having Re(590) and Rth(590) satisfying the above formulae (1) and (2), the cellulose ester film is more favorably used as a retardation film.

More preferred optical properties of the cellulose ester film differ between liquid-crystal modes to which the film is applied.

For VA-mode, Re of the film as measured at 590 nm preferably falls from 30 to 200 nm, more preferably from 30 to 150 nm, even more preferably from 40 to 100 nm. Rth of the film is preferably from 70 to 400 nm, more preferably from 100 to 300 nm, even more preferably from 100 to 250 nm.

In case where the cellulose ester film of the invention is laminated with an adhesive layer to give a laminate of the invention for further enhancing the wet heat durability of the laminate, Re of the film is preferably 35≦Re≦80, more preferably 40≦Re≦60. Rth of the film is preferably 50≦Rth≦300, more preferably 80≦Rth≦150. In case where the cellulose ester film of the invention is laminated with an adhesive layer to give a laminate of the invention for further enhancing the wet heat durability of the laminate, the ratio of Re to Rth, Re/Rth of the cellulose ester film is preferably from 0.2 to 0.6 for use for liquid-crystal display devices. Having Re/Rth as above, the film may provide a retardation film for VA mode with little color shift.

For TN mode, Re of the film, as measured at 590 nm, is preferably from 0 to 100 nm, more preferably from 20 to 90 nm, even more preferably from 50 to 80 nm. Rth of the film is preferably from 20 to 200 nm, more preferably from 30 to 150 nm, even more preferably from 40 to 120 nm.

An optically anisotropic layer may be provided on the cellulose ester film having the above-mentioned retardation, thereby giving an optical compensatory film for TN mode.

### (Haze of Film)

The haze of the cellulose ester film of the invention is preferably from 0.01 to 2.0%, more preferably from 0.05 to 1.5%, even more preferably from 0.1 to 1.0%, still more preferably at most 0.8%. Such a low level of haze fluctuation means that the proportion of a nonuniform structure is small in the film and the film is free from a risk of light leakage.

Film transparency is important for an optical film. The haze of the film may be measured using a haze meter, HGM-2DP (by Suga Test Instruments) and according to JIS K-6714.

### (Spectral Properties, Spectral Transmittance)

A sample of cellulose ester film, 13 mm×40 mm is analyzed with a spectrophotometer U-3210 (by Hitachi) at 25° C. and 60% RH for the transmittance at a wavelength of from 300 to 450 nm. The tilt range is represented by (72% wavelength)−(5% wavelength). The limiting wavelength is represented by (tilt range/2)+(5% wavelength); and the absorption end is represented by the wavelength for 0.4% transmittance. Accordingly, the transmittance at 380 nm and 350 nm can be evaluated.

In case where the cellulose ester film of the invention is used in a polarizer on the opposite side to the protective film thereof that faces a liquid-crystal cell, preferably, the spectral transmittance of the film, as measured according to the above-mentioned method at a wavelength of 380 nm, is from 45% to 95%, and the spectral transmittance thereof at a wavelength of 350 nm is at most 10%.

### (Glass Transition Temperature)

The glass transition temperature of the cellulose ester film of the invention is preferably not lower than 120° C., more preferably not lower than 140° C.

The glass transition temperature is measured using a differential scanning calorimeter (DSC), as follows: The film is heated at a heating rate of 10° C./min, and the temperature at which the base line begins to change as derived from the glass transition of the film, and the temperature at which the base line is again restored are measured, and the average of the data is the glass transition temperature of the film.

The glass transition temperature can also be measured using a dynamic viscoelastic analyzer as mentioned below. A sample, 5 mm×30 mm of the cellulose ester film (unstretched) of the invention is conditioned at 25° C. and 60% RH for at least 2 hours, and then analyzed with a dynamic viscoelastic analyzer, Vibron DVA-225 (by ITK). The chuck-to-chuck distance is 20 mm, the heating rate is 2° C./min, the measurement temperature range is from 30° C. to 250° C. and the frequency is 1 Hz. The storage elastic modulus is taken on the vertical axis as a logarithmic axis and the temperature (° C.) is taken on the vertical axis as a linear axis; in the solid region, a line 1 is drawn to the rapid decrease in the storage elastic modulus seen in the transference of the storage elastic modulus from the solid region to the glass transition region, and in the glass transition region, a line 2 is drawn thereto; and the intersection point between the line 1 and the line 2 is the glass transition temperature Tg (dynamic viscoelasticity), at which the storage elastic modulus of the film rapidly decreases in heating and the film begins to soften and at which the film begins to transfer to the glass transition region.

### (Equilibrium Water Content of Film)

The equilibrium water content of the cellulose ester film of the invention is preferably from 0 to 4% at 25° C. and 80% RH irrespective of the thickness thereof, in order that the film does not lose its adhesiveness to a water-soluble polymer such as polyvinyl alcohol when used as a protective film for polarizer, more preferably from 0.1 to 3.5%, even more preferably from 1 to 3%, still more preferably at most 2.5%. When the equilibrium water content is at most 4%, then it is favorable because, when the film is used as a support of an optical compensatory film, the retardation dependence thereof on humidity change may not be too large. When the water content is at most 3%, the wet heat stability of the film may be more bettered.

The water content may be measured as follows: A sample, 7 mm×35 mm of the cellulose ester film of the invention is analyzed using a water content analyzer and a sample drier, CA-03 and VA-05 (both by Mitsubishi Chemical) according to a Karl-Fischer moisture titration method. The water amount (g) is divided by the sample mass (g) to give the water content.

### (Moisture Permeability of Film)

The moisture permeability of the film is measured under the condition of 60° C. and 95% RH according to JIS Z-0208.

The moisture permeability of the cellulose ester film is smaller when the thickness thereof is larger, but is larger when the thickness is smaller. Therefore for samples each having a different thickness, the standard thickness must be set to be 80 μm, and the data must be correspondingly converted. The film thickness conversion may be attained according to the following numerical formula:

Moisture permeability of 80-μm thick film=[(measured moisture permeability)×(sample film thickness)μm)]/80 (μm).

For measurement of moisture permeability, referred to is the method described in “Physical Properties of Polymer II” (Lecture of Polymer Experiment 4, by Kyoritsu Publishing), pp. 285-294, “Measurement of Water Vapor Permeation (mass method, thermometer method, vapor pressure method, adsorption method)”

The moisture permeability of the cellulose ester film of the invention is preferably from 400 to 2000 g/m²·24 hrs, more preferably from 400 to 1800 g/m²·24 hrs, even more preferably from 400 to 1600 g/m²·24 hrs. When the moisture permeability is at most 2000 g/m²·24 hrs, then it is favorable since there does not occur a disadvantage that the absolute value of the moisture dependence of Re and Rth of the film is over 0.5 nm/% RH.

### (Dimensional Change of Film)

Regarding the dimensional stability of the cellulose ester film of the invention, it is desirable that both the dimensional change of the film kept under the condition of 60° C. and 90% RH for 24 hours (high humidity) and the dimensional change thereof kept under the condition of 90° C. and 5% RH for 24 hours (low humidity) are at most 0.5%, more preferably at most 0.3%, even more preferably at most 0.15%.

### (Elastic Modulus of Film)

Preferably, the elastic modulus of the cellulose ester film of the invention is from 200 to 500 kgf/mm², more preferably from 240 to 470 kgf/mm², even more preferably from 270 to 440 kgf/mm². A concrete method for measurement is described. Using a universal tensile tester, Toyo Boldwin's STM T50BP, the tension at 0.5% elongation of the film is measured in an atmosphere at 23° C. and 70% RH at a tension rate of 10%/min, and the elastic modulus of the film is derived from it.

### (Constitution of Cellulose Ester Film)

The cellulose ester film of the invention may be a single-layer film or may be composed of plural layers, but is preferably a single-layer film. “Single-layer” film as referred to herein means a sheet of cellulose ester film, not composed of plural film materials stuck together. This includes production of a sheet of cellulose ester film from plural cellulose ester solutions according to a successive casting system or a co-casting system.

In this case, the cellulose ester film to be produced may have a distribution in the thickness direction thereof by suitably changing and controlling the type and the amount of the additives thereto, the molecular weight distribution of the cellulose ester, and the type of the cellulose ester. The cellulose ester film of the invention includes another embodiment where one sheet of the film includes various functional parts such as an optical anisotropic part, an antiglare part, a gas barrier part and a moisture-resistant part.

### [Retardation Film]

The cellulose ester film of the invention may be used as a retardation film. “Retardation film” means an optical material having optical anisotropy and generally used in display devices such as liquid-crystal display devices, and has the same meaning as that of retardation plate, optical compensatory film and optical compensatory sheet. In a liquid-crystal display device, the retardation film acts to improve the contrast of the display panel and to improve the viewing angle characteristics and the image coloration.

Using the transparent cellulose ester film of the invention facilitates the production of a retardation film of which Re and Rth are controlled in any desired manner.

The retardation film of the invention has an optical anisotropic layer containing at least one liquid-crystal compound, on the cellulose ester film of the invention. A plurality of the cellulose ester films of the invention may be laminated or the cellulose ester film of the invention lay be laminated with any other film than the film of the invention, thereby giving a retardation film of which Re and Rth are suitably controlled. In laminating the films, usable are a sticky paste or an adhesive.

As the case may be, the cellulose ester film of the invention may be used as a support of a retardation film, and an optical anisotropic layer of liquid crystal or the like may be provided thereon to produce a retardation film. The optical anisotropic layer to be applied to the retardation film of the invention may be formed of, for example, a composition containing a liquid-crystal compound, or may be formed of a cellulose ester film having a birefringence, or may be formed of the cellulose ester film of the invention.

The liquid-crystal compound is preferably a discotic liquid-crystal compound or a rod-shaped liquid-crystal compound.

### (Discotic Liquid-Crystal Compound)

Examples of discotic liquid-crystal compounds usable in the invention are described in various publications (for example, C. Destrade et al., Mol. Crysr. Liq. Cryst., Vol. 71, page 111 (1981); Quarterly Journal of Chemical Review, edited by the Chemical Society of Japan, No. 22, Chemistry of Liquid Crystal, Chap. 5, Chap. 10, Sec. 2 (1994); B. Kohne et al., Angew. Chem. Soc. Chem. Comm., page 1794 (1985); J. Zhang et al., J. Am. Chem. Soc., Vol. 116, page 2655 (1994)).

In the optical anisotropic layer, the discotic liquid-crystal molecules are preferably fixed in an aligned state, most preferably fixed through polymerization. Polymerization of discotic liquid-crystal molecules is described in JP-A 8-27284. For fixing discotic liquid-crystal molecules through polymerization, a polymerizing group must be bonded to the discotic core of the discotic liquid-crystal molecule as a substituent therein. However, when a polymerizing group is bonded to the discotic core, the molecule could hardly keep the alignment state during polymerization. Accordingly, a linking group is introduced between the discotic core and the polymerizing group. Discotic liquid-crystal molecules having a polymerizing group are disclosed in JP-A 2001-4387.

### [Laminate]

The cellulose ester film of the invention may be laminated with an adhesive layer to form a laminate. Hereinafter, an cellulose acylate film may be used as an example of the cellulose ester film but the invention is not limited to the cellulose acylate film.

The laminate is preferably such that, when the laminate is put on a glass sheet with its adhesive layer kept in contact with the glass sheet and then left as such at 60° C. and at a relative humidity of 90% for 1000 hours and when the thus-left laminate is observed with a polarizing microscope, an acicular crystal structure or a granular structure is not seen both in the interface between the adhesive layer and the cellulose acylate film and in the interface between the adhesive layer and the glass sheet, and the haze of the laminate is at most 5%. In the preferred embodiment of the laminate, any acicular or spherical crystal structure is not seen in the wet heat environment test, and therefore when the laminate is incorporated in a liquid-crystal display device, the display contrast is prevented from being lowered even though the device is left in a wet heat atmosphere for a long period of time.

More preferably, the haze of the laminate is at most 4% under the above condition, even more preferably at most 3%.

Also more preferably, the laminate is such that, when the laminate is put on a glass sheet with its adhesive layer kept in contact with the glass sheet and then left as such at 60° C. and at a relative humidity of 90% for 1000 hours and when the thus-left laminate is observed with a polarizing microscope, an acicular crystal structure or a granular structure is not seen in the interface between the adhesive layer or the cellulose acylate film and in the interface between the adhesive layer and the glass sheet, and even more preferably it is not seen in the interface between the adhesive layer or the cellulose acylate film and in the interface between the adhesive layer and the glass sheet.

The laminate contains an adhesive layer and the cellulose acylate film, and the adhesive layer may be laminated on one side of the cellulose acylate film or on both sides thereof. The production method for the laminate is not specifically defined, and the laminate may be produced in any known production method. For example, a solid adhesive layer may be stuck to the cellulose acylate film owing to its own adhesive force, or a liquid adhesive layer is first applied thereonto and cured to thereby form the intended adhesive layer on the cellulose acylate film. Anyhow, the invention is not limited to these examples.

### <Adhesive Layer>

The laminate has an adhesive layer so that it may be stuck to any other member such as other optical film, liquid crystal cell or the like. The adhesive layer contains at least an adhesive.

In general, a suitable adhesive layer may be used in forming the adhesive layer. The adhesive includes rubber-based adhesive, acrylic adhesive, silicone-based adhesive, urethane-based adhesive, vinyl alkyl ether-based adhesive, polyvinyl alcohol-based adhesive, polyvinylpyrrolidone-based adhesive, polyacrylamide-based adhesive, cellulose-based adhesive.

Of such adhesives, preferably used are those excellent in optical transparency, having suitable adhesive properties such as wettability, aggregability and stickiness, and excellent in weather resistance and heat resistance. Acrylic adhesives are preferred, as satisfying such characteristics. Especially preferred are adhesives comprising an acrylic polymer and a crosslinking agent.

The acrylic adhesive comprises, as the base polymer, an acrylic polymer having a main skeleton with a monomer unit of an alkyl (meth)acrylate. Alkyl (meth)acrylate is meant to indicate alkyl acrylate and/or alkyl methacrylate, and in this description, the same shall apply to the expression (meth). The alkyl (meth)acrylate to constitute the main skeleton of the acrylic polymer includes a linear chain or branched chain alkyl group having from 1 to 20 carbon atoms. For example, its examples include methyl (meth)acrylate, ethyl (meth)acrylate, propyl (meth)acrylate, butyl (meth)acrylate, 2-ethylhexyl (meth)acrylate, isooctyl (meth)acrylate, isononyl (meth)acrylate, isomyristyl (meth)acrylate, lauryl (meth)acrylate. One or more of these may be used here either singly or as combined. Preferably, the mean carbon number of the alkyl group is from 3 to 9.

Preferably, the base polymer to constitute the acrylic polymer preferably has a main skeleton with a monomer unit of an alkyl (meth)acrylate having a high degree of hydrophobicity from the viewpoint of controlling the equilibrium water content of the polymer to be low. In general, in practical use of the film, the alkyl (meth)acrylate preferably has a linear chain or branched chain alkyl group having from 3 to 9 carbon atoms, more preferably from 4 to 8 carbon atoms, from the viewpoint of the above-mentioned optical transparency and suitable wettability, aggregability, stickiness, weather resistance and heat resistance. Of the alkyl groups, those having a larger number of carbon atoms are preferred for increasing the hydrophobicity of the film and for reducing the equilibrium water content thereof. Alkyl (meth)acrylates of the type includes butyl (meth)acrylate and isooctyl (meth)acrylate. Of those, butyl acrylate is preferred in the invention as the hardness of the adhesive is favorable and the adhesive does not cause film unevenness in durability test.

For improving the adhesiveness and the heat resistance thereof, one or more comonomers may be introduced into the acrylic polymer through copolymerization. Specific examples of the comonomer include, for example, hydroxyl group-having monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate; carboxyl group-having monomers such as (meth) acrylic acid, carboxyethyl (meth)acrylate, carboxypentyl (meth)acrylate, itaconic acid, maleic acid, fumaric acid, crotonic acid; acid anhydride group-having monomers such as maleic anhydride, itaconic anhydride; acrylic acid-caprolactone adduct; sulfonic acid group-having monomers such as styrenesulfonic acid, allylsulfonic acid, 2-(meth)acrylamide-2-methylpropanesulfonic acid, (meth) acrylamidopropanesulfonic acid, sulfopropyl (meth)acrylate, (meth) acryloyloxynaphthalenesulfonic acid; phosphoric acid group-having monomers such as 2-hydroxyethyl acryloylphosphate, etc.

In addition, also mentioned as examples of monomers for property modification are (N-substituted) amide monomers such as (meth) acrylamide, N,N-dimethyl(meth)acrylamide, N-butyl(meth)acrylamide, N-methylol(meth)acrylamide, N-methylolpropane(meth)acrylamide; alkylaminoalkyl (meth)acrylate monomers such as aminoethyl (meth)acrylate, N,N-dimethylaminoethyl (meth)acrylate, tert-butylaminoethyl (meth)acrylate; alkoxyalkyl (meth)acrylate monomers such as methoxyethyl (meth)acrylate, ethoxyethyl (meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, N-acryloylmorpholine; maleimide monomers such as N-cyclohexylmaleimide, N-isopropylmaleimide, N-laurylmaleimide, N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, N-laurylitaconimide, etc.

As the property-modifying monomer, further usable herein are vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarbonamides, styrene, α-methylstyrene, N-vinylcaprolactam; cyanoacrylate monomers such as acrylonitrile, methacrylonitrile; epoxy group-having acrylic monomers such as glycidyl (meth)acrylate; glycol acrylate monomers such as polyethylene glycol (meth)acrylate, polypropylene glycol (meth)acrylate, methoxyethylene glycol (meth)acrylate, methoxypolypropylene glycol (meth)acrylate; acrylate monomers such as tetrahydrofurfuryl (meth)acrylate, fluoro(meth)acrylate, silicone (meth)acrylate, 2-methoxyethyl acrylate, etc.

Not specifically defined, the proportion of the comonomer in the acrylic polymer is preferably from 0 to 30% or so, more preferably from 0.1 to 15% or so in terms of percentage by weight of all the constitutive monomers.

Of those comonomers, preferred are hydroxyl group-having monomers, carboxyl group-having monomers and acid anhydride group-having monomers in view of the adhesiveness to liquid crystal cell and the durability of the polymer for use for optical films. These monomers are to be the reaction point with crosslinking agent. Hydroxyl group-having monomers, carboxyl group-having monomers and acid anhydride group-having monomers are rich in the reactivity with an intermolecular crosslinking agent, and are therefor preferably used here for the purpose of enhancing the aggregability and the heat resistance of the adhesive layer to be formed. For example, as the hydroxyl group-having monomers, it is desirable to use those in which the alkyl group of the hydroxyalkyl group are more bulky, such as 4-hydroxybutyl (meth)acrylate, more preferably 6-hydroxyhexyl (meth)acrylate rather than 2-hydroxyethyl (meth)acrylate. In case where such a hydroxyl group-having monomer is used as the comonomer, its proportion is preferably from 0.01 to 5%, more preferably from 0.01 to 3% in terms of the ratio thereof by weight to all the constitutive monomers. In case where a carboxyl group-having monomer is used as the comonomer, its proportion is preferably from 0.01 to 10%, more preferably from 0.01 to 7% in terms of the ratio thereof by weight to all the constitutive monomers.

The mean molecular weight of the acrylic polymer is not specifically defined, and the weight-average molecular weight thereof is preferably from 100,000 to 2,500,000 or so. The acrylic polymer may be produced according to various known methods, for which, for example, a radical polymerization method such as a bulk polymerization method, a solution polymerization method or a suspension polymerization may be suitably selected. As the radical polymerization initiator, various known azo-type and peroxide-type initiators can be used. The reaction temperature may be generally from 50 to 80° C. or so, and the reaction time may be from 1 to 8 hours. Of the above-mentioned production methods, especially preferred is a solution polymerization method. As the solvent for the acrylic polymer, generally used is ethyl acetate, toluene or the like. The solution concentration may be generally from 20 to 80% by weight.

The adhesive is preferably in the form of an adhesive composition containing a crosslinking agent. The polyfunctional compound capable of being incorporated in the adhesive composition includes an organic crosslinking agent and a polyfunctional metal chelate. The organic crosslinking agent includes epoxy-type crosslinking agents, isocyanate-type crosslinking agents, imine-type crosslinking agents, and peroxide-type crosslinking agents. One or more such crosslinking agents may be used here either singly or as combined. As the organic crosslinking agent, preferred are isocyanate-type crosslinking agents. Preferably, the isocyanate-type crosslinking agent is combined with a peroxide-type crosslinking agent. The polyfunctional metal chelate comprises a polyvalent metal and an organic compound bonding to each other in a mode of covalent bonding or coordination bonding. The polyvalent metal atom includes Al, Cr, Zr, Co, Cu, Fe, Ni, V, Zn, In, Ca, Mg, Mn, Y, Ce, Sr, Ba, Mo, La, Sn, and Ti. The atom in the organic compound that participates in covalent bonding or coordination bonding is, for example, an oxygen atom. The organic compound includes alkyl esters, alcohol compounds, carboxylic acid compounds, ether compounds, and ketone compounds.

The blend ratio of the base polymer such as an acrylic polymer and the crosslinking agent is not specifically defined. In general, the amount of the crosslinking agent (as solid) is preferably from 0.001 to 20 parts by weight or so, more preferably from 0.01 to 15 parts by weight or so, relative to 100 parts by weight (as solid) of the base polymer. As the crosslinking agent, preferred are isocyanate-type crosslinking agents and peroxide-type crosslinking agents. The amount of the peroxide-type crosslinking agent is preferably from 0.01 to 3 parts by weight or so (as solid), more preferably from 0.02 to 2.5 parts by weight or so, even more preferably from 0.05 to 2.0 parts by weight or so, relative to 100 parts by weight of the base polymer. The amount of the isocyanate-type crosslinking agent is preferably from 0.001 to 2 parts by weight or so (as solid), more preferably from 0.01 to 1.5 parts by weight or so, relative to 100 parts by weight of the base polymer. The isocyanate-type crosslinking agent and the peroxide-type crosslinking agent may be used in the amount falling within the above range, and preferably, these may be combined for use here.

Further if desired, various additives such as silane coupling agent, tackifier, plasticizer, glass fibers, glass beads, antioxidant, UV absorbent, transparent particles and the like may be added to the adhesive within an range not overstepping the scope and the spirit of the invention.

As the additive, preferred is a silane coupling agent. Preferably, a silane coupling agent is added to the adhesive in an amount of from 0.001 to 10 parts by weight or so (as solid), more preferably from 0.005 to 5 parts by weight or so relative to 100 parts by weight (as solid) of the base polymer. As the silane coupling agent, those heretofore known in the art can be used with no specific limitation. For example, herein usable are epoxy group-having silane coupling agents such as γ-glycidoxypropyltrimethoxysilane, γ-glycidoxypropyltriethoxysilane, γ-glycidoxypropylmethyldiethoxysilane, and 2-(3,4-epoxycyclohexyl)ethyltrimethoxysilane; amino group-having silane coupling agents such as 3-aminopropyltrimethoxysilane, N-2-(aminoethyl)-3-aminopropylmethyldimethxoysilane, and 3-triethoxysilyl-N-(1,3-dimethylbutylidene)propylamine; acryl group-having silane coupling agents such as 3-aryloxypropyltrimethoxysilane, and 3-methacryloxypropyltriethoxysilane; and isocyanate group-having silane coupling agents such as 3-isocyanatopropyltriethoxysilane.

The base polymer of the rubber-based adhesive includes, for example, natural rubber, isoprene rubber, styrene-butadiene rubber regenerated rubber, polyisobutylene rubber, styrene-isoprene-styrene rubber, and styrene-butadiene-styrene rubber. The base polymer of the silicone-based adhesive includes, for example, dimethylpolysiloxane, and diphenylpolysiloxane. A functional group such as carboxyl group may be introduced into these base polymers.

In a preferred embodiment of the invention, butyl acrylate is the main ingredient substance to be contained in the adhesive layer.

Adhesives comprising butyl acrylate as the main ingredient are described in JP-A 2008-144126. Of those, preferred for use herein are the adhesives shown in Table 1 in the patent publication, and more preferred are those except the adhesive A6 in Table 1 in the patent publication. Specifically, adhesives except those comprising butyl acrylate alone as the starting monomer for the acrylic polymer are preferably used in the invention; and the laminate produced by laminating the adhesive layer containing the adhesive of the type and the cellulose acylate film of the invention can especially noticeably prevent the bleeding of the adhesive in the adhesive layer.

The laminate may have the adhesive layer on only one side of the cellulose acylate film or on both sides thereof.

Preferably, the thickness of the adhesive layer is from 10% to 50% of the thickness of the laminate, more preferably from 20% to 40%.

### [Polarizer]

The polarizer of the invention has a protective film on both sides of a polarizing element, in which at least one protective film is the cellulose ester film of the invention or the retardation film of the invention. Specifically, the film of the invention can be used as a protective film for polarizer. As described above, a polarizer is produced by laminating a protective film on at least one side of a polarizing element. The polarizing element for use in the invention may be a known one, and is, for example, a hydrophilic polymer film such as a polyvinyl alcohol film is processed with a dichroic dye such as iodine and then stretched. The method of sticking the cellulose ester film and the polarizing element to each other is not specifically defined. For example, the two may be stuck together with an adhesive of an aqueous solution of a water-soluble polymer. As the water-soluble polymer adhesive, preferred is an aqueous solution of a completely saponified polyvinyl alcohol.

The polarizer comprising the film of the invention is degraded little under a high-temperature high-humidity condition and can keep stable properties for a long period of time.

The polarizer of the invention is characterized by comprising the film of the invention. In case where the film of the invention is used as the protective film for polarizer, preferred is a constitution of protective film for polarizer/polarizing element/protective film for polarizer/liquid-crystal cell/protective film for polarizer of the invention/polarizing element/protective film for polarizer, or a constitution of protective film for polarizer/polarizing element/protective film for polarizer of the invention/liquid-crystal cell/protective film for polarizer of the invention/polarizing element/protective film for polarizer. In particular, sticking the polarizer to a TN-mode, VA-mode or OCB-mode liquid-crystal cell provides a display device having a broad viewing angle and excellent in visibility with little discoloration.

The laminate produced by laminating the cellulose ester film of the invention with an adhesive layer for the purpose of further improving the wet heat durability thereof has good wet heat durability and is used as a protective film for polarizer. Specifically, the polarizer contains at least one laminate of the type. In the polarizer, the adhesive layer of the laminate may be adjacent to the polarizing element, or may not be adjacent thereto. On the other hand, in case where the polarizer is incorporated in a liquid-crystal display device, preferred is an embodiment where the adhesive layer of the laminate is adjacent to the liquid-crystal cell of the liquid-crystal display device.

The polarizer is produced by laminating a protective film on at least one side of a polarizing element. The polarizing element may be any known one, and for example, it may be produced by processing a hydrophilic polymer film such as a polyvinyl alcohol film with a dichroic dye such as iodine and then stretching it. The sticking of the cellulose ester film and the polarizing element to each other is not specifically defined, and for example, the two may be stuck together with an adhesive of an aqueous solution of a water-soluble polymer. Preferably, the water-soluble polymer adhesive is an aqueous solution of a completely saponified polyvinyl alcohol.

In the laminate produced by laminating the cellulose ester film of the invention with an adhesive layer and therefore having further improved wet heat durability, the adhesive layer is preferably adjacent to the liquid-crystal cell. Preferably, therefore, the laminate is in a constitution of protective film for polarizer/polarizing element/protective film for polarizer/liquid-crystal cell/laminate/polarizing element/protective film for polarizer, or in a constitution of protective film for polarizer/polarizing element/laminate/liquid-crystal cell/laminate/polarizing element/protective film for polarizer. In particular, sticking the laminate to a TN-mode, VA-mode or OCB-mode liquid-crystal cell provides a display device having a broad viewing angle and excellent in visibility with little discoloration. In particular, the polarizer comprising the protective film for polarizer mentioned above is degraded little under a high-temperature high-humidity condition and can keep stable properties for a long period of time.

In case where the polarizer of the invention comprises the laminate produced by laminating the cellulose ester film of the invention with an adhesive layer for further enhancing the wet heat durability thereof, the polarizer is preferably such that the contrast reduction with it before and after kept at 60° C. and 90% RH for 1000 hours is at most 10%.

### [Liquid-Crystal Display Device]

The polarizer of the invention is preferably used in a liquid-crystal display device. In particular, sticking the polarizer to a TN-mode, VA-mode or OCB-mode liquid-crystal cell provides a liquid-crystal display device having a broad viewing angle and excellent in visibility with little discoloration. In particular, in the liquid-crystal display device constructed by incorporating the laminate-having polarizer, the panel contrast is reduced little even in a high-temperature high-humidity condition, and the display device is degraded little and can keep stable properties for a long period of time.

The liquid-crystal display device of the invention comprises a liquid-crystal cell and two polarizers arranged on both sides of the cell, in which at least one polarizer is the polarizer of the invention.

In the liquid-crystal display device of the invention, the liquid-crystal cell is preferably a VA-mode or TN-mode liquid-crystal cell, more preferably a VA-mode cell, from the viewpoint that the film of the invention in the display device of the type can express its Re and Rth falling within the above-mentioned preferred range.

The cellulose ester film and the polarizer comprising the film of the invention are usable in liquid crystal cells and liquid crystal display devices of various display modes. For these, proposed are various modes of TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic) modes.

In the VA-mode liquid crystal cell, rod-shaped liquid crystal molecules are aligned substantially vertically under no voltage application.

The VA-mode liquid crystal cell includes, in addition to (1) the VA-mode liquid crystal cell of a narrow sense, where rod-shaped liquid crystal molecules are aligned substantially vertically under no voltage application and are aligned horizontally under voltage application (described in JP-A 2-176625), (2) a multidomained VA-mode (MVA-mode) liquid crystal cell with enlarged viewing angles (in SID 97, Digest of Tech. Papers (preprints) 28 (1997), 845), (3) a liquid crystal cell of an n-ASM mode in which the rod-shaped liquid crystal molecules are aligned substantially vertically under no voltage application and are aligned in twisted multi-domains under voltage application (in Sharp Technical Report, No. 80, p. 11), and (4) a liquid crystal cell of a SURVIVAL mode (in Monthly Journal of Display, May, p. 14 (1999)).

The VA-mode liquid crystal display device contains a liquid crystal cell and two polarizers disposed on both sides thereof. The liquid crystal cell carries a liquid crystal between two electrode substrates. In one embodiment of a transmission-type liquid crystal display device of the invention, one film of the invention is disposed between the liquid crystal cell and one polarizer, or two films of the invention are between the liquid crystal cell and both polarizers.

In another embodiment of a transmission-type liquid crystal display device of the invention, an optically-compensatory sheet comprising the film of the invention is used as the transparent protective film of the polarizer to be disposed between the liquid crystal cell and the polarizing element. The optically-compensatory sheet may be used as only the protective film for one polarizer (between the liquid crystal cell and the polarizing element), or the optically-compensatory sheet may be used as the two protective films for both polarizers (between the liquid crystal cell and the polarizing element). In case where the optically-compensatory sheet is used only for one polarizer, preferably, the sheet serves as the protective film on the liquid crystal cell side of the backlight-side polarizer adjacent to the liquid crystal cell. When stuck to the liquid crystal cell, preferably, the film of the invention is on the VA-cell side. The protective film may be any ordinary cellulose film, and is preferably thinner than the film of the invention. For example, its thickness is preferably from 40 to 80 μm. Not limited thereto, the film includes commercial KC4UX2M (by Konica-Opto, 40 μm), KC5UX (by Konica-Opto, 60 μm), TD80 (by FUJIFILM, 80 μm), etc.

### EXAMPLES

The characteristics of the invention are described more concretely with reference to the following Examples. In the following Examples, the material used, its amount and the ratio, the details of the treatment and the treatment process may be suitably modified or changed. Accordingly, the invention should not be limitatively interpreted by the Examples mentioned below.

### (Preparation of Cellulose Acylate)

Various cellulose acylates differing from each other in the type of the acyl group therein and the degree of acyl substitution were prepared as in Table 3. For preparing these, a catalyst of sulfuric acid (in an amount of 7.8 parts by mass relative to 100 parts by mass of cellulose) was added to cellulose, and a carboxylic acid to be the starting material of the acyl substituent was added thereto and reacted for acylation at 40° C. In this, the type and the amount of the carboxylic acid were changed to thereby control the type of the acyl group and the degree of acyl substitution. After the acylation, the product was ripened at 40° C. The resulting cellulose acylate was washed with acetone to remove the low-molecular ingredient. Regarding the type of cellulose acylate in the Table, Bu for the substituent B means a butyryl group, and Pr means a propionyl group.

TABLE 3

| | | | | Total Degree of |
|---|---|---|---|---|
| Cellulose | Degree of Acetyl | | Degree of | Substitution |
| Ester | Substitution A | Other Substituent B | Substitution with B | A + B |
| C-1 | 2.87 | — | — | 2.87 |
| C-2 | 2.81 | — | — | 2.81 |
| C-3 | 2.56 | — | — | 2.56 |
| C-4 | 2.43 | — | — | 2.43 |
| C-5 | 2.02 | Bu | 0.70 | 2.72 |
| C-6 | 1.70 | Pr | 1.00 | 2.70 |

### [Formation of Cellulose Acylate Film]

The cellulose acylate dope mentioned below was cast into a film according to a solution casting method. Thus formed, the film was used in Examples 1 to 33.

### (Cellulose Acylate Dope A)

| | |
|---|---|
| Cellulose Acylate Resin, having a substituent | 100 mas. pts. |
| and a degree of substitution as in Table 3 | |
| Additive A, as in Table 1 | Amount as in Table 4 |
| | (mas. pts.) |
| Compound A | 4 mas. pts. |
| Dichloromethane | 406 mas. pts. |
| Methanol | 61 mas. pts. |

Compound A:

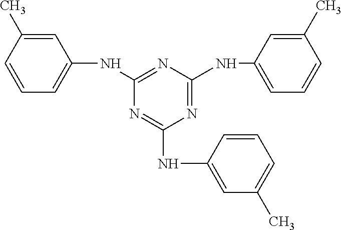

A mat agent dispersion of fine particles (Aerosil R972, by Nippon Aerosil, having a secondary mean particle size of at most 1.0 μm) was added to the dope A in an amount of 0.13 parts by mass relative to 100 parts by mass of the cellulose acylate therein, and mixed therein by stirring.

### (Cellulose Acylate Dope B)

A cellulose acylate dope B was prepared in the same manner as that for the cellulose acylate dope A, to which, however, 4 parts by mass of the compound A was not added. This was used in Example 7 and what follows, and in Comparative Examples.

### (Solution Casting Method)

The above composition was put into a mixing tank and stirred to dissolve the ingredients. The solution was filtered through a paper filter having a mean pore size of 34 μm and a sintered metal filter having a mean pore size of 10 μm thereby preparing a cellulose acylate dope. The dope was cast, using a and caster. Peeled from the band, the film having a residual solvent amount of about 30% by mass was stretched by 30% in the cross direction using a tenter with applying thereto hot air at 140° C. Subsequently, the tenter transference was changed to roll transference, and the film was dried at 120° C. to 150° C. and wound up. The film thickness is shown in Table 4.

### (Measurement of Retardation)

Thus produced, the cellulose acylate film was conditioned at 25° C. and 60% RH for at least 2 hours, and then analyzed with a birefringence meter (KOBRA 21ADH by Oji Scientific Instruments) at 25° C. and at a relative humidity of 60% to thereby determine its Re and Rth at a wavelength of 590 nm. The data are shown in Table 4.

### (Internal Haze)

The haze was measured as follows: A sample, 40 mm×80 mm of the cellulose ester film of the invention was analyzed with a haze meter HGM-2DP (by Suga Test Instruments) at 25° C. and 60% RH, according to JIS K-6714. The data are shown in Table 4.

### (Durability)

The produced cellulose acylate film was wound up into a roll, and from it, a sample having a of 100 mm×100 mm was cut out, and kept at 60° C. and at a relative humidity of 90% for 500 hours. After this, the sample was visually or microscopically checked for the bleeding out of the additive, and evaluated according to the following standards. The results are shown in Table 4.

A: Good with no change.
B: Slight bleeding was seen with a 100-power microscope, but good.
C: Some bleeding was partly seen with a 100-power microscope, but no problem in practical use.
D: Bleeding was seen, and the haze increased and the contrast lowered.
E: Much bleeding was seen, and practically useless.

TABLE 4

| | | Additive | | | | | |
|---|---|---|---|---|---|---|---|
| | Cellulose | | Amount Added | | | Internal | |
| No. | Acylate | Type | (mas. pts.) | Re (nm) | Rth (nm) | Haze (%) | Durability*¹ |
| Example 1 | C-1 | A-3 | 11 | 48 | 120 | 0.05 | B |
| | | Compound A | 4 | | | | |
| Example 2 | C-2 | A-3 | 11 | 51 | 123 | 0.04 | B |
| | | Compound A | 4 | | | | |
| Example 3 | C-3 | A-3 | 11 | 52 | 120 | 0.05 | A |
| | | Compound A | 4 | | | | |
| Example 4 | C-4 | A-3 | 11 | 58 | 125 | 0.04 | A |
| | | Compound A | 4 | | | | |
| Example 5 | C-5 | A-3 | 11 | 48 | 112 | 0.12 | B |
| | | Compound A | 4 | | | | |
| Example 6 | C-6 | A-3 | 11 | 50 | 110 | 0.10 | B |
| | | Compound A | 4 | | | | |
| Example 7 | C-4 | A-1 | 18 | 50 | 120 | 0.05 | B |
| Example 8 | C-4 | A-2 | 18 | 51 | 123 | 0.04 | B |
| Example 9 | C-4 | A-3 | 18 | 55 | 130 | 0.08 | A |
| Example 10 | C-4 | A-4 | 18 | 60 | 125 | 0.09 | C |
| Example 11 | C-4 | A-5 | 18 | 50 | 116 | 0.05 | A |
| Example 12 | C-4 | A-6 | 18 | 45 | 110 | 0.09 | B |
| Example 13 | C-4 | A-7 | 18 | 60 | 120 | 0.10 | C |
| Example 14 | C-4 | A-9 | 18 | 48 | 112 | 0.12 | B |
| Example 15 | C-4 | A-12 | 18 | 53 | 125 | 0.11 | B |
| Example 16 | C-4 | A-15 | 18 | 40 | 115 | 0.10 | B |
| Example 17 | C-4 | A-17 | 18 | 58 | 130 | 0.04 | B |
| Example 18 | C-4 | A-18 | 18 | 60 | 130 | 0.05 | B |
| Example 19 | C-4 | A-20 | 18 | 52 | 125 | 0.11 | A |
| Example 20 | C-4 | A-21 | 18 | 52 | 125 | 0.11 | A |
| Example 21 | C-4 | A-22 | 18 | 58 | 130 | 0.12 | C |
| Example 22 | C-4 | A-24 | 18 | 52 | 118 | 0.05 | A |
| Example 23 | C-4 | A-26 | 18 | 53 | 120 | 0.14 | B |
| Example 24 | C-4 | A-28 | 18 | 52 | 118 | 0.05 | A |
| Example 25 | C-4 | A-30 | 18 | 50 | 110 | 0.06 | B |
| Example 26 | C-4 | A-31 | 18 | 50 | 110 | 0.06 | C |
| Example 27 | C-4 | A-3 | 10 | 50 | 120 | 0.07 | B |
| Example 28 | C-4 | A-3 | 35 | 52 | 122 | 0.05 | C |
| Example 29 | C-4 | B-3 | 18 | 52 | 122 | 0.05 | C |
| Example 30 | C-4 | B-9 | 18 | 52 | 123 | 0.25 | C |
| Example 31 | C-4 | B-10 | 18 | 53 | 127 | 2.50 | C |
| Example 32 | C-4 | A-3 | 3 | 53 | 127 | 2.50 | C |
| Example 33 | C-4 | A-3 | 45 | 51 | 121 | 2.00 | C |
| Comparative | C-4 | B-1 | 18 | 45 | 110 | 0.08 | E |
| Example 1 | | | | | | | |
| Comparative | C-4 | B-2 | 18 | 42 | 108 | 0.07 | E |
| Example 2 | | | | | | | |
| Comparative | C-4 | B-5 | 18 | 58 | 130 | 1.50 | E |
| Example 3 | | | | | | | |
| Comparative | C-4 | B-7 | 18 | 43 | 124 | 0.20 | E |
| Example 4 | | | | | | | |
| Comparative | C-4 | B-8 | 18 | 52 | 122 | 0.20 | D |
| Example 5 | | | | | | | |

As obvious from Table 4, use of the polycondensate ester in the invention (Examples 1 to 33) provides a cellulose acylate film excellent in durability with time and having high Re and Rth, and therefore suitable for retardation film.

In case where the polycondensate ester falling outside the invention is used (Comparative Examples 1 to 5), Re and Rth of the formed film could be controlled on a favorable level, but the additive bled out with time, and therefore the film had surface defects and was unsatisfactory in point of the durability.

### Example 34

### Co-Cast Film

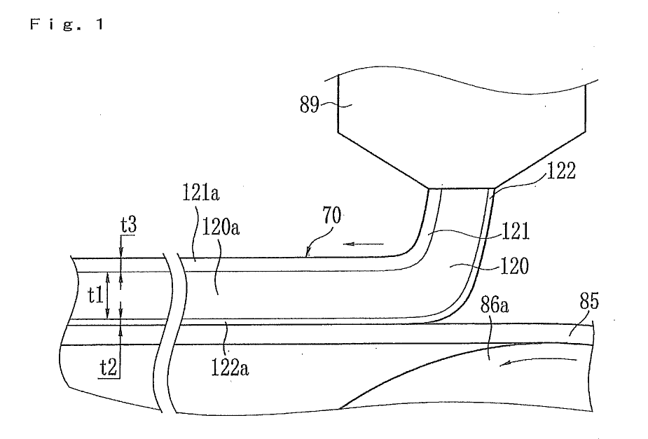

Dopes shown in Table 5 were prepared in the same manner as in Example 7. FIG. 1 is referred to. As illustrated therein, the three dopes were co-cast from the casting die 89 onto a running cast band 85. In this, the casting amount of each dope was suitably controlled in simultaneous multilayer co-casting to give a cast film 70, in which the inner layer was made thickest. Finally after stretched, the thickness of the inner layer of the film was 55 μm, and that of the surface layer A and the surface layer B was 2.5 μm each. While having a residual solvent amount of about 30% by mass, the film was peeled away from the band, and stretched by 30% in the cross direction using a tenter while hot air at 140° C. was applied thereto. Subsequently, the tenter transference was changed to roll transference, and the film was further dried at 120° C. to 150° C. and wound up. The retardation, the internal haze and the durability of the film were determined according to the above, and the results are shown in Table 5.

TABLE 5

| | | Additive | | | | | |
|---|---|---|---|---|---|---|---|
| Layer | Cellulose | | Amount Added | | | Internal | |
| Constitution | Acylate | Type | (mas. pts.) | Re (nm) | Rth (nm) | Haze (%) | Durability |
| Surface Layer A | C-2 | A-5 | 12 | 48 | 120 | 0.06 | B |
| Inner Layer | C-4 | A-5 | 18 | | | | |
| Surface Layer B | C-2 | A-5 | 12 | | | | |

As obvious from Table 5, use of the polycondensate ester in the invention provides a cellulose acylate film having a low internal haze, excellent in durability with time and having high Re and Rth, and therefore the film is suitable for retardation film.

### Example 35, Comparative Examples 6 and 7

### Production of Polarizer

A stretched polyvinyl alcohol was made to adsorb iodine to prepare a polarizing element.

Using a polyvinyl alcohol adhesive, the film of Example 7 and Comparative Examples 1 to 2 was stuck to one side of the polarizing element. The film was saponified under the condition mentioned below. An aqueous solution of sodium hydroxide (1.5 mol/L) was prepared and kept warmed at 55° C. An aqueous solution of diluted sulfuric acid (0.005 mol/L) was prepared and kept warmed at 35° C. The formed cellulose acylate film was dipped in the aqueous sodium hydroxide solution for 2 minutes, and then dipped in water to fully remove the aqueous sodium hydroxide solution. Next, this was dipped in the aqueous diluted sulfuric acid solution for 1 minute, and then dipped in water to fully remove the aqueous diluted sulfuric acid solution. Finally, the film was fully dried at 120° C.

A commercial cellulose acylate film (Fujitac TD80UF, by FUJIFILM) was saponified, and using a polyvinyl alcohol adhesive, this was stuck to the other side of the polarizing element, and dried at 70° C. for at least 10 minutes. The polarizing element and the cellulose acylate film were so arranged that the transmission axis of the former could be parallel to the slow axis of the latter. The polarizing element and the commercial cellulose triacylate film were so arranged that the transmission axis of the former could be perpendicular to the slow axis of the latter.

The polarizer of Example 35 was visually checked for the bleeding of the additive, after left at 60° C. and a relative humidity of 90% for 500 hours; and its excellent durability was confirmed. The polarizers of Comparative Examples 6 and 7 bled out the additive to such a level that the polarizer would be practically useless, and the durability thereof was insufficient.

### Example 36

### Mounting on VA Panel

As the upper polarizer and the lower polarizer (backlight side) of the above liquid-crystal display device comprising a vertically-aligned liquid-crystal cell, the polarizer comprising the cellulose acetate film of Example 35 was stuck to the liquid-crystal cell in such as manner that the cellulose acetate film thereof could face the liquid-crystal cell. The upper polarizer and the lower polarizer were stuck to the liquid-crystal cell via an adhesive. These are in a cross-Nicol configuration of such that the transmission axis of the upper polarizer is in the vertical direction and the transmission axis of the lower polarizer is in the horizontal direction.

A square wave voltage of 55 Hz was applied to the liquid-crystal cell. The mode was a normally black mode in which the white level display was at 5V and the black level display was at 0V. The transmittance (%) at the time of black level of display at a viewing angle of azimuth angle of 45 degrees and polar angle of 60 degrees for black level display, and the color shift between the display at azimuth angle 45 degrees and polar angle 60 degrees, and the display at azimuth angle 180 degrees and polar angle 60 degrees were determined.

The transmittance ratio (white display/black display), was taken as the contrast ratio. Using a contrast gauge (EZ-Contrast 160D, by ELDIM), the viewing angle (indicating the polar angle range having a contrast ratio of at least 10 with no gradation reversal in black display) was measured in 8 levels of from black display (L1) to white display (L8).

The liquid-crystal display device produced here was observed, and as a result, the liquid-crystal panel comprising the film of the invention realized neutral black display in both the front direction and the viewing angle direction.

The viewing angle (the polar angle range having a contrast ratio of at least 10 with no gradation reversal in black display) was a polar angle of at least 80° in both the vertical direction and the horizontal direction, and the color shift at the time of black level of display was less than 0.02 and extremely small.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2009-158264, filed on Jul. 2, 2009, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose ester film comprising at least one polycondensate ester, wherein the polycondensate ester comprises:
a dicarboxylic acid residue mixture having an average carbon number of from 5.5 to 10.0 and comprising at least one aromatic dicarboxylic acid residue and at least one aliphatic dicarboxylic acid residue, and
at least one aliphatic diol residue having an average carbon number of from 2.5 to 7.0.

2. The cellulose ester film according to claim 1, wherein the aromatic dicarboxylic acid residue in the dicarboxylic acid residue is at least 40 mol %.

3. The cellulose ester film according to claim 1, wherein the number-average molecular weight of the polycondensate ester is from 500 to 2000.

4. The cellulose ester film according to claim 1, wherein the polycondensate ester is a polyester polyol.

5. The cellulose ester film according to claim 1, wherein the terminal of the polycondensate ester is an aliphatic monocarboxylic acid residue.

6. The cellulose ester film according to claim 5, wherein the aliphatic monocarboxylic acid residue is an ester-forming derivative of an aliphatic monocarboxylic acid having a carbon number of at most 3.

7. The cellulose ester film according to claim 1, wherein the cellulose ester film comprises a cellulose acylate and the degree of acyl substitution of the cellulose acylate is from 2.00 to 2.95.

8. The cellulose ester film according to claim 7, wherein the content of the polycondensate ester is from 5 to 40 parts by mass relative to 100 parts by mass of the cellulose acylate.

9. The cellulose ester film according to claim 1, wherein the cellulose ester film is stretched in the cross direction, and the draw ratio in stretching is from 5% to 100% in the direction perpendicular to the machine direction.

10. The cellulose ester film according to claim 1, wherein the cellulose ester film is formed according to a solution casting film formation method and then stretched.

11. The cellulose ester film according to claim 10, wherein the solution-casting film formation method is a simultaneous or successive multilayer casting film formation by co-casting.

12. The cellulose ester film according to claim 1, satisfying the following formulae (1) and (2):
25 nm≦|Re(590)|≦100 nm, (1)
50 nm≦|Rth(590)|≦250 nm, (2)
wherein Re(590) and Rth(590) each mean the in-plane retardation and the thickness-direction retardation of the film as measured with a light having a wavelength of 590 nm at 25° C. and 60% RH.

13. The cellulose ester film according to claim 1, having a thickness of from 30 to 100 μm.

14. A polarizer having a protective film on both sides of a polarizing element, wherein at least one protective film is a cellulose ester film comprising at least one polycondensate ester, wherein the polycondensate ester comprises:
a dicarboxylic acid residue mixture having an average carbon number of from 5.5 to 10.0 and comprising at least one aromatic dicarboxylic acid residue and at least one aliphatic dicarboxylic acid residue, and
at least one aliphatic diol residue having an average carbon number of from 2.5 to 7.0.

15. A liquid-crystal display device comprising a liquid-crystal cell and two polarizers arranged on both sides thereof, wherein at least one polarizer has a protective film on both sides of a polarizing element, and at least one protective film is a cellulose ester film comprising at least one polycondensate ester that comprises:
a dicarboxylic acid residue mixture having an average carbon number of from 5.5 to 10.0 and comprising at least one aromatic dicarboxylic acid residue and at least one aliphatic dicarboxylic acid residue, and
at least one aliphatic diol residue having an average carbon number of from 2.5 to 7.0.

16. The liquid-crystal display device according to claim 15, wherein the liquid-crystal cell is a VA-mode liquid-crystal cell.
